(19) United States
(12) Patent Application Publication
(10) Pub. No.: US 2024/0397322 A1
(43) Pub. Date: Nov. 28, 2024

(54) PROVISIONING A SECURED PACKET

(71) Applicant: Lenovo (Singapore) Pte. Ltd., New Tech Park (SG)

(72) Inventors: Sheeba Backia Mary Baskaran, Friedrichsdorf (DE); Genadi Velev, Darmstadt (DE); Roozbeh Atarius, La Jolla, CA (US); Andreas Kunz, Ladenburg (DE)

(21) Appl. No.: 18/693,139

(22) PCT Filed: Sep. 16, 2022
(86) PCT No.: PCT/IB2022/058741

§ 371 Date: Mar. 18, 2024

Related U.S. Application Data
(60) Provisional application No. 63/245,154, filed on Sep. 16, 2021.

(51) Int. Cl. H04W 12/30; H04W 12/72

(52) U.S. Cl. CPC H04W 12/35; H04W 12/72

(57) ABSTRACT

Apparatuses, methods, and systems are disclosed for provisioning a Secured Packet. One method includes sending, to a Secured Packet Application Function, a request for a credential related to a device and a service descriptor and receiving, from the Secured Packet Application Function, a secured packet and credential information, the credential information including: a subscriber identity corresponding to the device, a lifetime for the Secured Packet, a network service identifier, a device storage requirement indication, or a combination thereof. The method includes storing the secured packet and the credential information and provisioning the secured packet to the device via an update procedure, where the secured packet including the valid credential.

### CROSS-REFERENCE TO RELATED APPLICATIONS

This application claims priority to U.S. Provisional Patent Application No. 63/245,154 entitled “SECURE PACKET RETRIEVAL PROCEDURE ENHANCEMENTS” and filed on 16 Sep. 2021 for Sheeba Backia Mary Baskaran, Genadi Velev, Roozbeh Atarius, and Andreas Kunz, which application is incorporated herein by reference.

### FIELD

The subject matter disclosed herein relates generally to wireless communications and more particularly relates to enhancements to the secure packet retrieval procedure.

### BACKGROUND

Currently in Third Generation Partnership Project (“3GPP”), the network function(s) (“NF(s)”) in the Home Public Land Mobile Network (“HPLMN”) provisions or update the credentials used for Network Slice Authentication and Authorization (“NSAA”) or credentials for secondary authentication/authorization to the User Equipment (“UE”).

### BRIEF SUMMARY

Disclosed are procedures for provisioning a Secured Packet. Said procedures may be implemented by apparatus, systems, methods, or computer program products.

One method at a consumer network function (“consumer NF”) includes sending, to a Secured Packet Application Function (“SP-AF”), a request for a credential related to a device and a service descriptor, and receiving, from the SP-AF, a secured packet and credential information including: a subscriber identity corresponding to the device, a lifetime for the secured packet, a network service identifier, a device storage requirement indication, or a combination thereof. The method includes storing the secured packet and the credential information and provisioning the secured packet to the device via an update procedure, the secured packet including a valid credential.

One method at a SP-AF includes receiving, from a network function, a request for a credential related to a device and a service descriptor. The method includes determining whether a valid credential exists for the device and the service descriptor and sending, to the network function, a failure indication in response to determining that the valid credential does not exist for the device and the service descriptor. The method includes generating a secured packet in response to determining that the valid credential exists for the device and the service descriptor and sending, to the network function, the secured packet and credential information including: a subscriber identity corresponding to the device, a lifetime for the secured packet, a network service identifier, a device storage requirement indication, or a combination thereof.

One method at a Network Exposure Function (“NEF”) includes receiving, from a consumer NF, a first request message for a credential related to a device and a service descriptor, where the first request message includes a destination address. The method includes sending, to a SP-AF using the destination address, a second request message for the credential related to the device and the service descriptor. The method includes receiving, from the SP-AF, a first response message including a secured packet and credential information and sending, to the consumer NF, a second response message including the secured packet and the credential information. Here, the credential information includes: a subscriber identity corresponding to the device, a lifetime for the Secured Packet, a network service identifier, a device storage requirement indication, or a combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for provisioning a Secured Packet;

FIG. 2 is a block diagram illustrating one embodiment of a 5G New Radio (“NR”) protocol stack;

FIG. 3 is a diagram illustrating one embodiment of a 3GPP consumer NF requesting a SP-AF to provide via a NEF a secured packet related to slice authentication and authorization;

FIG. 4 is a diagram illustrating one embodiment of a 3GPP consumer NF requesting a SP-AF to provide via a NEF a secured packet related to secondary authentication;

FIG. 5 is a diagram illustrating one embodiment of a 3GPP consumer NF requesting a SP-AF to provide a secured packet related to slice authentication and authorization;

FIG. 6 is a diagram illustrating one embodiment of a 3GPP consumer NF requesting a SP-AF to provide a secured packet related to secondary authentication;

FIG. 7 is a block diagram illustrating one embodiment of a user equipment apparatus that may be used for provisioning a Secured Packet;

FIG. 8 is a block diagram illustrating one embodiment of a network apparatus that may be used for provisioning a Secured Packet;

FIG. 9 is a flowchart diagram illustrating one embodiment of a first method for provisioning a Secured Packet;

FIG. 10 is a flowchart diagram illustrating one embodiment of a second method for provisioning a Secured Packet; and

FIG. 11 is a flowchart diagram illustrating one embodiment of a third method for provisioning a Secured Packet.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for mechanisms for provisioning a Secured Packet. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Currently in 3GPP, the NF(s) in the HPLMN provisions or update the credentials used for Network Slice-Specific Authentication and Authorization (“NSSAA”) or credentials for secondary authentication/authorization (referred to hereafter as “Secondary Authentication”) to the UE. The credentials may be preconfigured in the Unified Data Management function (“UDM”), or the UDM can request and securely receive the credentials from the corresponding application function (“AF”) (e.g., a Provisioning Server). On request from the UDM, if an AF is to provision and/or update the UE's credentials (i.e., on Mobile Equipment (“ME”) and/or Universal Integrated Circuit Card (“UICC”)), then the AF sends the credentials as secured packet to the UDM which will later be passed to the UE.

According to current 3GPP specification, the existing procedure for transfer of a secure packet from an AF to a UDM entity involved sending a request from the UDM to the AF, which message includes the Subscriber Permanent Identity (“SUPI”). However, exposing the SUPI to an external service provider or external AF breaches user privacy.

Further, in the existing procedure the UDM does not invoke a service-specific provisioning request with an AF, so the existing request does not allow the AF to provide credentials and/or parameters specific to the particular service type when the AF is in control of performing provisioning for more than one type of service for the UE.

According to a first solution, the Network Function (“NF”) consumer (e.g., UDM) sends to the NEF a provisioning data request. Here, the provisioning data request may include at least one of: a generic public subscription identifier (“GPSI”), an external network slice information (“ENSI”) or single network slice selection assistance information (“S-NSSAI”), a Data Type, and an indication to provide a secured packet. This indication may include the parameter UiccConfigurationParameter. In one embodiment, the ENSI/S-NSSAI may also be indicated in the parameter UiccConfigurationParameter. The consumer NF receives—from the NEF—a provisioning data response. Here, the provisioning data response includes at least one of: a success indication, the secured packet, the GPSI, the ENSI or S-NSSAI, and a lifetime parameter indicating the validity period of the secured packet and/or of credentials in the secured packet. Alternatively, the provisioning data response may include at least one of: a failure indication, the GPSI, and the ENSI or S-NSSAI. The consumer NF stores the above received information.

According to the first solution, the NEF sends to a SP-AF a Hypertext Transfer Protocol (“HTTP”) POST request message and receives a response message from the SP-AF. Here, the POST request message may include at least one of: the GPSI, the ENSI or S-NSSAI, the Data Type, and an indication to provide a secured packet. This indication may include the parameter UiccConfigurationParameter. In one embodiment, the ENSI/S-NSSAI may also be indicated in the parameter UiccConfigurationParameter. In certain embodiments, the response from the SP-AF is a ‘200 OK’ message containing the secured packet. In one embodiment, the ‘200 OK’ message includes the GPSI, the ENSI/S-NSSAI, and the lifetime parameter indicating the validity period of the secured packet and/or of credentials in the secured packet. In other embodiments, the response from the SP-AF includes a failure indication, the GPSI, and the ENSI/S-NSSAI. In some embodiments, the response from the SP-AF includes an indication if the secured packet has to be stored in the ‘ME’ or ‘UICC.’

According to a second solution, the consumer NF (e.g., UDM) sends to the SP-AF a HTTP POST request message and receives a response message from the SP-AF. Here, the POST request message may include at least one of: the SUPI, the S-NSSAI, the Data Type, and an indication to provide a secured packet, and a lifetime parameter indicating the validity period of the secured packet and/or of credentials in the secured packet. This indication may include the parameter UiccConfigurationParameter. In one embodiment, the S-NSSAI can be indicated in (UiccConfigurationParameter). In certain embodiments, the response from the SP-AF is a HTTP ‘200 OK’ message containing the secured packet. In one embodiment, the ‘200 OK’ message includes the SUPI, the S-NSSAI, and the lifetime parameter. In other embodiments, the response from the SP-AF includes a failure indication, the SUPI, and the S-NSSAI. In some embodiments, the response from the SP-AF includes an indication if the secured packet has to be stored in the ‘ME’ or ‘UICC.’ The consumer NF stores the above received information.

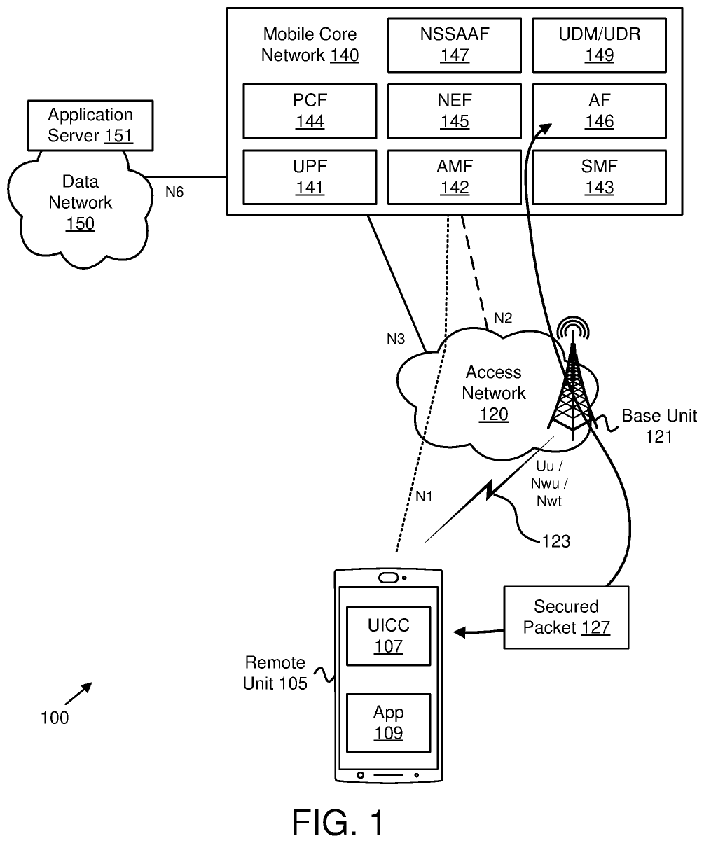

FIG. 1 depicts a wireless communication system 100 for provisioning a Secured Packet, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network, with the RAN 120 being an intermediate network that provides the at least one remote unit 105 with access to the mobile core network 140. The RAN 120 may be composed of a base unit 121 with which the at least one remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G cellular system specified in the 3GPP specifications. For example, the RAN 120 may be a Next Generation Radio Access Network (“NG-RAN”), implementing NR Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example, the Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”), such as a UICC 107, and a ME providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Furthermore, the UL communication signals may comprise one or more uplink channels, such as the Physical Uplink Control Channel (“PUCCH”) and/or Physical Uplink Shared Channel (“PUSCH”), while the DL communication signals may comprise one or more DL channels, such as the Physical Downlink Control Channel (“PDCCH”) and/or Physical Downlink Shared Channel (“PDSCH”).

In the following, an UL transmission may refer to a PUSCH transmission, a PUCCH transmission, Random Access Channel (“RACH”) transmission, and/or an UL signal.

In various embodiments, the remote units 105 may communicate directly with each other (e.g., device-to-device communication) using sidelink communication. Here, sidelink transmissions may occur on sidelink resources. A remote unit 105 may be provided with different sidelink communication resources according to different allocation modes. As used herein, a “resource pool” refers to a set of resources assigned for sidelink operation. A resource pool consists of a set of resource blocks (i.e., Physical Resource Blocks (“PRB”)) over one or more time units (e.g., Orthogonal Frequency Division Multiplexing (“OFDM”) symbols, subframe, slots, subslots, etc.). In some embodiments, the set of resource blocks comprises contiguous PRBs in the frequency domain. A PRB, as used herein, consists of twelve consecutive subcarriers in the frequency domain. It should be mentioned that throughout the disclosure, the terms symbol, slot, subslot and transmission time interval (“TTI”) refers to a time unit with a particular duration (e.g., symbol could be a fraction/percentage of an OFDM symbol length associated with a particular subcarrier spacing (“SCS”)).

In some embodiments, the remote units 105 communicate with an application server 151 via a network connection with the mobile core network 140. For example, an application 109 (e.g., web browser, media client, telephone and/or Voice-over-Internet-Protocol (“VoIP”) application) in a remote unit 105 may trigger the remote unit 105 to establish a protocol data unit (“PDU”) session (or Packet Data Network (“PDN”) connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

To facilitate cell access, the RAN 120 transmits (e.g., periodically) a synchronization signal (e.g., primary synchronization signal and secondary synchronization signal) and Physical Broadcast Channel (“PBCH”), which comprise a synchronization signal block (“SSB”). For example, each base unit 121 in the RAN 120 may transmit a set of SSB. The periodicity, number repetitions, time-domain location/offset, and other parameters of the SSB may depend on the carrier frequency and subcarrier spacing (“SCS”) of the cell. The remote unit 105 uses the information in the SSB to access a particular cell using a single-carrier waveform, e.g., by transmitting a connection request to a respective base unit 121 supporting the particular cell.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 142 that serves the RAN 120, a Session Management Function (“SMF”) 143, a Policy Control Function (“PCF”) 144, a Network Exposure Function (“NEF”) 145, an Application Function (“AF”) 146, a Network Slice-Specific Authentication and Authorization Function (“NSSAAF”′) 147, a UDM and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 142 is responsible for termination of Non-Access Spectrum (“NAS”) signaling, NAS ciphering and integrity protection, registration management, connection management, mobility management, access authentication and authorization, security context management. The SMF 143 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 144 is responsible for unified policy framework, providing policy rules to CP functions, access subscription information for policy decisions in UDR. The NEF 145 is responsible for making network data and resources easily accessible to customers and network partners.

The AF 146 may establish the quality of service and certain charging aspects for a service. In such a role, the AF 146 may interconnect with the PCF 144. In some embodiments, the AF 146 allows NF service consumers to subscribe, modify and unsubscribe for application events. In such embodiments, the AF 146 may notify NF service consumers with a corresponding subscription about observed events on the AF.

As described herein, the AF 146 may act as a provisioning server that may provision and/or update the credentials of the remote unit 105. In such embodiments, the AF 146 may send the credentials as a Secured Packet to the UDM which will be later passed to the remote unit 105. While depicted as residing within the mobile core network 140, in other embodiments the AF 146 may be a server external to the mobile core network 140.

The AF 146 offers SP-AF services to a consumer NF, (such as the UPF 141, the SMF 143, the NSSAAF 147, and/or the UDM/UDR 149) via a “Nspaf” service-based interface. The consumer NF makes use of the SP-AF services when it needs to protect UE parameters for which the final consumer is the Universal Subscriber Identity Module (“USIM”) (see, e.g., 3GPP Technical Specification (“TS”) 33.501, clause 6.15.2.1). Such protected UE parameters may be transferred using a Secured Packet.

As used herein, a “Secured Packet” refers to a packet for exchange between an entity in a network (e.g., in the mobile core network 140) and a UICC 107 (e.g., SIM/USIM) and/or ME in a remote unit 105, where security mechanisms are applied to the packet, thus creating a Secured Packet. In various embodiments, the structure of the Secured Packets complies with the one defined in European Telecommunications Standards Institute (“ETSI”) TS 102 225 v16.0.0, e.g., comprising a header and Secured data.

Secured Packets contain application messages to which certain security mechanisms have been applied, e.g., according to ETSI TS 102 224 v15.0.0. Application messages are commands or data exchanged between an application resident in or behind the PLMN and on the UICC/SIM/USIM. The Sending/Receiving Entity in the PLMN and the UICC are responsible for applying the security mechanisms to the application messages and thus turning them into Secured Packets.

The NSSAAF 147 is used by the AMF 142 to communicate with an Authentication, Authorization, and Accounting (“AAA”) server when it needs to invoke NSSAA for a specific remote unit 105 and a specific S-NSSAI. The NSSAA procedure is triggered for a network slice (e.g., identified by S-NSSAI) requiring NSSAA with the AAA server which may be hosted by the HPLMN operator or by a third party which has a business relationship with the HPLMN. The AMF 142 may use the NSSAAF In certain embodiments, the NSSAAF 147 is also used by the AMF 142 to receive slice re-authentication notification or slice authorization revocation notification.

The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third-party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), an Authentication Server Function (“AUSF”), or other NFs defined for the 5GC. When present, the AUSF may act as an authentication server and/or authentication proxy, thereby allowing the AMF 142 to authenticate a remote unit 105. In certain embodiments, the mobile core network 140 may include an AAA server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 143 and UPF 141. In some embodiments, the different network slices may share some common network functions, such as the AMF 142. The different network slices are not shown in FIG. 1 for ease of illustration, but their support is assumed.

While FIG. 1 depicts components of a 5G RAN and a 5G core network, the described embodiments for provisioning a Secured Packet apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 142 may be mapped to an MME, the SMF 143 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), base station unit, Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for provisioning a Secured Packet.

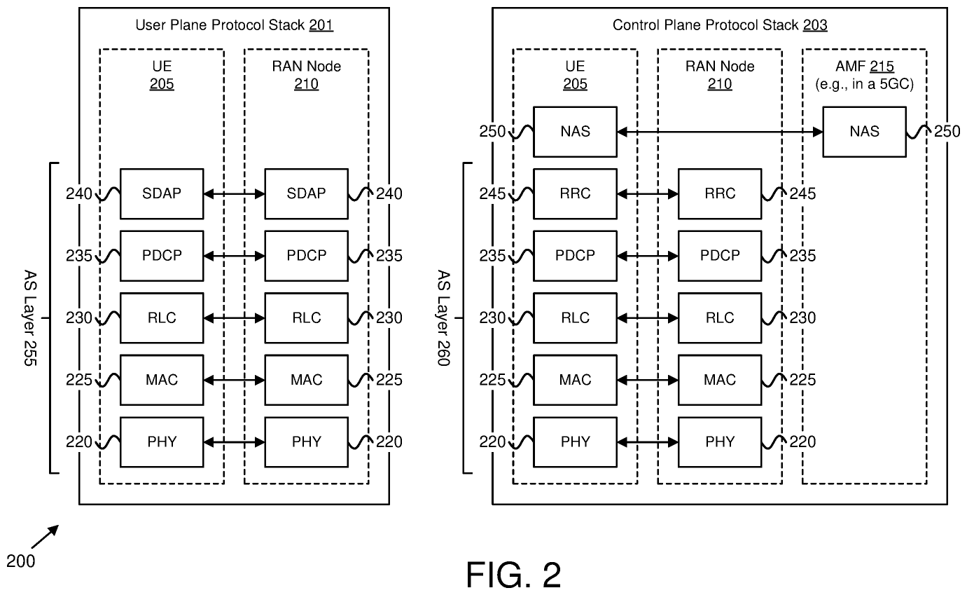

FIG. 2 depicts a NR protocol stack 200, according to embodiments of the disclosure. While FIG. 2 shows the UE 205, the RAN node 210 and an AMF 215 in a 5G core network (“5GC”), these are representative of a set of remote units 105 interacting with a base unit 121 and a mobile core network 140. As depicted, the NR protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) layer 240. The Control Plane protocol stack 203 includes a PHY layer 220, a MAC sublayer 225, a RLC sublayer 230, and a PDCP sublayer 235. The Control Plane protocol stack 203 also includes a Radio Resource Control (“RRC”) layer 245 and a Non-Access Stratum (“NAS”) layer 250.

The Access Stratum (“AS”) layer 255 (also referred to as “AS protocol stack”) for the User Plane protocol stack 201 consists of at least SDAP, PDCP, RLC and MAC sublayers, and the physical layer. The AS layer 260 for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC layer 245 and the NAS layer 250 for the control plane and includes, e.g., an IP layer and/or PDU Layer (not depicted) for the user plane. L1 and L2 are referred to as “lower layers,” while L3 and above (e.g., transport layer, application layer) are referred to as “higher layers” or “upper layers.”

The PHY layer 220 offers transport channels to the MAC sublayer 225. The PHY layer 220 may perform a beam failure detection procedure using energy detection thresholds, as described herein. In certain embodiments, the PHY layer 220 may send an indication of beam failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and an AMF 215 in the 5GC. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC sublayer 230 above is through logical channels. The MAC sublayer 225 therefore performs multiplexing and demultiplexing between logical channels and transport channels: the MAC sublayer 225 in the transmitting side constructs MAC PDUs (also known as transport blocks (“TBs”)) from MAC Service Data Units (“SDUs”) received through logical channels, and the MAC sublayer 225 in the receiving side recovers MAC SDUs from MAC PDUs received through transport channels.

The MAC sublayer 225 provides a data transfer service for the RLC sublayer 230 through logical channels, which are either control logical channels which carry control data (e.g., RRC signaling) or traffic logical channels which carry user plane data. On the other hand, the data from the MAC sublayer 225 is exchanged with the PHY layer 220 through transport channels, which are classified as UL or DL. Data is multiplexed into transport channels depending on how it is transmitted over the air.

The PHY layer 220 is responsible for the actual transmission of data and control information via the air interface, i.e., the PHY layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of physical resource blocks, etc.

3GPP Technical Report (“TR”) 33.857-60 identifies a Key Issue #2: Provisioning of Credentials, which deals with the remote provisioning of non-USIM credentials for a standalone Non-Public Networks (“NPN”) and a Public Network Integrated NPN (“PNI-NPN”), e.g., a non-public network deployed with the support of a PLMN. This Key Issue aims at studying the corresponding security implications related to the provisioning. For PNI-NPNs, only credentials for secondary and slice-specific authentication need to be considered in this key issue.

The UDM in the HPLMN may provide functionalities to provision and/or update the credentials used for NSSAA or credentials for Secondary Authentication to the UE 205. The credentials may be preconfigured on the UDM or securely sent from an AF such as a Provisioning Server to the UDM via NEF. If the credentials are to be provisioned to the UE's UICC, the Provisioning Server may secure the credentials before sending to the UDM. If the credentials are to be provisioned to the UE (i.e., on ME/UICC), the AF sends the credentials as secured packet to the UDM which can be based on the existing procedure, e.g., as specified in 3GPP TS 29.544, which can have some drawbacks as described below.

In certain embodiments, to retrieve a secured packet, the consumer NF sends a request to the SP-AF to provide a secured packet, where the request contains the UE's identity (/{supi}) and the UICC configuration parameter.

At Step 1, the consumer NF sends a POST request (custom method: provide-secured-packet) to the resource (i.e., AF 146) representing the SUPI.

At Step 2a, upon success, the AF 146 responds with a “200 OK” message that contains the requested Secured Packet.

However, at Step 2b, if the resource does not exist (e.g., the SUPI is unknown in the AF 146), then the AF 146 responds with the HTTP status code “404 Not Found”. In certain embodiments, additional error information is included in the response body (e.g., in a “ProblemDetails” element).

On failure, the appropriate HTTP status code indicating the error is to be returned and appropriate additional error information should be returned in the POST response body.

However, the above procedure uses SUPI and UICC Configuration parameter as input, therefore the SUPI may be exposed which may have some security risks. Additionally, the SUPI and the UICC Configuration parameter may not provide any service-specific information to indicate the SP-AF the service for which the credentials/configuration parameters need to be provisioned/updated for the UE in the ME/UICC.

Disclosed herein are solutions to enhance the Secured Packet Retrieval procedure between a 3GPP NF and an Application Function (AF). Such enhancements include a procedure to use privacy protected UE identifier (“ID”) to protect UE/User Privacy where any external/third party AF is involved. Described herein is a procedure for service-specific Secured Packet Retrieval and a procedure to support the UDM to request and receive Credentials/Configuration parameters from an external/third party SP-AF via a NEF.

The following solutions take into account the following network function and application function terminology clarifications. Note that the 3GPP NF consumer described in this disclosure can correspond to a UDM, or a Steering of Roaming Application Function (“SoR-AF”), or a NSSAAF, or a NEF, or any consumer NF. Note that the AF specified in this disclosure can correspond to any AF, or application server, or AAA server, or SP-AF. The enhanced Secured packet retrieval procedure described in this disclosure can be applied by any NF in the 3GPP network to retrieve any credentials/configuration parameters from any application.

Disclosed herein are embodiments of a first solution relating to enhancements to Secured Packet Retrieval procedure to support UE privacy protected and service-specific credential(s)/parameter(s) retrieval (involving NEF). The first solution describes how a 3GPP NF can request a service-specific provisioning and/or updating credentials/parameter(s) from an external or third-party AF (i.e., when the AF is outside the 3GPP network) during a secured packet retrieval procedure.

The first solution may include the following scenarios, A and B, respectively:

Scenario-A relates to NSSAA-related credentials Retrieval. Here, the first solution defines a new NEF service operation message (e.g., “Nnef_Provisioning_Data” service operation message) and the related processing for NSSAA-related credentials retrieval. The NF consumer (i.e., UDM) uses the new NEF service operation message to perform request/response procedure with NEF related to Secure packet retrieval related to slice authentication credentials.

In Scenario-A, the NEF sending S-NSSAI (or ENSI) in the POST request (custom method: provide-secured-packet) to the resource representing the privacy protected UE ID (i.e., GPSI or any external UE ID) for the case when a Network Slice specific credential/parameter needs to be fetched from the SP-AF. The NEF receives the GPSI, S-NSSAI/ENSI, Lifetime from the SP-AF and forwards this to the NF consumer.

Scenario-B relates to Secondary Authentication related credentials Retrieval. Here, the first solution defines the new NEF service operation message (e.g., “Nnef_Provisioning_Data” service operation message) and the related processing for Secondary Authentication related credentials retrieval. The NF-consumer (i.e., UDM) using new NEF service operation message to perform request/response procedure with NEF related to Secure packet retrieval related to Secondary Authentication credentials.

In Scenario-B, the NF-consumer sends DN-specific ID and/or Data Network Name (“DNN”) in the POST request (custom method: provide-secured-packet) to the resource representing the privacy protected UE ID (i.e., GPSI or any external UE ID) for the case when a DNN-specific Secondary Authentication credential/parameter needs to be fetched from the SP-AF. The NEF receives the GPSI, DN-specific ID, DNN, Lifetime from the SP-AF and forwarding to NF consumer.

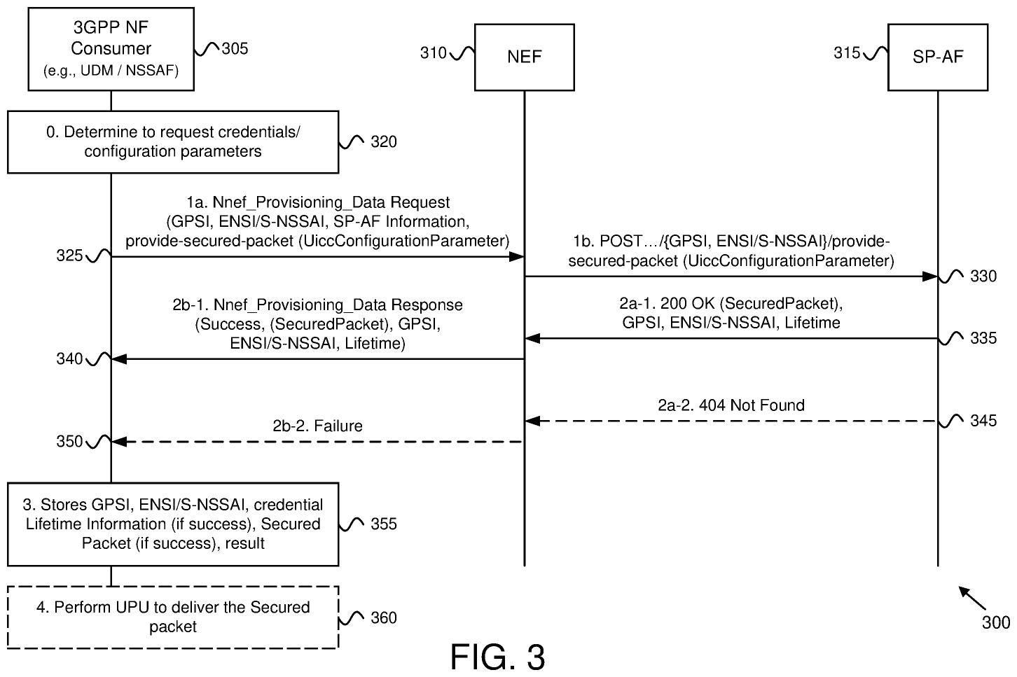

FIG. 3 depicts a procedure 300 for NSSAA-based secure credential retrieval, according to embodiments of the disclosure. The procedure 300 is an example implementation of the first solution for Scenario-A. The procedure 300 involves a 3GPP NF consumer 305 (e.g., a UDM or NSSAAF), a NEF 310, and a SP-AF 315. The steps shown in FIG. 3 are described as follows:

At Step 0, the 3GPP NF consumer 305 determines to request NSSAA-related credentials/configuration parameter(s) for a UE 205 (see block 320). Here, the determination may be based on local policy, or based on expiry of third-party network slice credentials, or based on non-availability of third-party network slice credentials corresponding to an ENSI/S-NSSAI.

At Step 1a, the 3GPP NF consumer 305 sends a Nnef_Provisioning_Data Request service operation message to the NEF 310 (see messaging 325). Here, the service operation message comprises at least a UE ID (e.g., GPSI), a Service-specific descriptor/information set (e.g., ENSI/S-NSSAI), SP-AF information (e.g., SP-AF ID and/or address information of the SP-AF 315), and an indicator ‘provide-secured-packet’ comprising parameter UiccConfigurationParameter.

The purpose of the Service-specific information/descriptor is that it indicates to the UDM and the SP-AF 315 that the contents of the packet are the credentials/configuration parameter(s) related to the specific given service to be provisioned for the UE 205.

Alternatively, the new service name can be represented as ‘Nnef_ProvisioningData_Get request/response’, where the service name is “Nnef_ProvisioningData”, the service operation is “Get” and the operation semantic “request/response”.

Alternatively, the message of Step 1a may also comprise a ‘Data Type’ information element which is used by the 3GPP NF consumer 305 (e.g., UDM) to indicate to the SP-AF 315 what data (e.g., Routing ID, or Steering of Roaming (“SoR”) Data, or Network slice data, or any third-party service data, etc.) is required to be provisioned to the UDM as part of credentials and/or configuration parameter(s) from the SP-AF 315 for the UE 205. While FIG. 3 depicts the service operation message comprising a GPSI, in other embodiments the 3GPP NF consumer 305 may send a SUPI as the UE ID in Step 1a.

At Step 1b, upon receiving the message of Step 1a, the NEF 310 sends a HTTP POST request message to the SP-AF 315 based on the received SP-AF ID/address information (see messaging 330). Here, the POST request comprises the UE ID (/{GPSI}), the Service-specific descriptor/information set (e.g., ENSI/S-NSSAI), and the UICC configuration parameter. The NEF 310 sends the POST request (custom method: provide-secured-packet) to the resource representing the GPSI and the ENSI/S-NSSAI. Note that if the received message of Step 1a comprises a SUPI as the UE ID, then the NEF 310 translates the SUPI of the UE 205 into a GPSI corresponding to the UE 205. Here, the NEF 310 sends the GPSI of the UE 205 to the SP-AF 315 because the SP-AF 315 is not a trusted entity, therefore the 3GPP NF consumer 305 interacts with the SP-AF 315 via the NEF 310.

Upon receipt of Step 1b, either Step 2a-1 or Step 2b-1 is performed (e.g., based on success or failure).

At Step 2a-1, on success, the SP-AF 315 responds with a HTTP “200 OK” message (see messaging 335). Here, the HTTP “200 OK” message contains the requested Secured Packet, the UE ID (e.g., GPSI), the Service-specific descriptor/information set (e.g., ENSI/S-NSSAI), and Lifetime information (corresponding to the validity of the secured packet or of the credentials in the secured packet). Alternatively, in Step 2a-1, the SP-AF 315 can also include an indication of whether the secured packet is to be stored in the ‘ME’ or ‘UICC.’

At Step 2b-1, if the resource does not exist (e.g., if the GPSI is unknown in the SP-AF 315), then the SP-AF 315 returns the HTTP status code “404 Not Found” (see messaging 345). In some embodiments, the HTTP “404 Not Found” message comprises a Failure indication, the UE ID (e.g., GPSI), the Service-specific descriptor/information set (e.g., ENSI/S-NSSAI), and additional error information in the response body (e.g., in a “ProblemDetails” element). On failure, the appropriate HTTP status code indicating the error is returned and appropriate additional error information may be returned in the POST response body.

At Step 2a-2, if the NEF 310 receives an “200 OK” message in Step 2a-1, then the NEF 310 sends a Nnef_Provisioning_Data Response service operation message to the 3GPP NF consumer 305 (see messaging 340). Here, the service operation message comprises a Success indication, the UE ID (e.g., GPSI), the Service-specific descriptor/information set (e.g., ENSI/S-NSSAI), the Secured Packet, and the Lifetime information. Alternatively, if in Step 2a-1 the NEF 310 receives an indication whether the secured packet has to be stored in the ‘ME’ or ‘UICC’, then the NEF 310 sends the received indication in Nnef_Provisioining_Data Response service operation message to the 3GPP NF consumer 305 along with the other information.

At Step 2b-2, the NEF 310 if receives “404 Not Found” or an HTTP POST message comprising the failure case in Step 2b-1, then the NEF 310 sends a Nnef_Provisioning_Data Response service operation message to the 3GPP NF consumer 305 (see messaging 350). Here, the service operation message comprises the Failure indication, the UE ID (e.g., GPSI), and the Service-specific descriptor/information set (e.g., ENSI/S-NSSAI).

Note that if the received message of Step 1a comprises a SUPI as the UE ID, then the NEF 310 translates the GPSI in the received message of Step 2a-1 (success case) or Step 2b-1 (failure case) back to the SUPI corresponding to the UE 205.

At Step 3, the 3GPP NF consumer 305 stores (i.e., locally or in the UDR) the received UE ID (e.g., GPSI), the received Service-specific descriptor/information set (e.g., ENSI/S-NSSAI), and a provisioning retrieval result (see block 355). Additionally, the 3GPP NF consumer 305 stores, as the result, either the Secured Packet and the credential lifetime information received in the success case (i.e., described in Step 2a-1 and Step 2a-2); or the failure indication received in the failure case (i.e., described in Step 2b-1 and Step 2b-2). Here, storing in the UDR may be based on the UE ID (e.g., GPSI).

At optional Step 4, if the 3GPP NF consumer 305 consumer receives, in Step 2a-1, an indication that the Secured Packet has to be stored in the ‘ME’ or ‘UICC,’ then the 3GPP NF consumer 305 stores the received indication along with other data and uses this indication to determine if a UE Parameters Update (“UPU”) procedure is to be triggered to store the UPU data/secured packet in the ME/UICC of the UE 205 (see block 360). Here, the UDM may initiate the UPU procedure. Further, the UDM may also provide an indication (i.e., the indication that the secured packet has to be stored in the ‘ME’ or ‘UICC’) to the UE 205 along with the UPU data/secured packet during the UPU procedure to request the UE 205 to store the UPU data/secured packet in the ‘ME’ or the ‘UICC,’ as indicated by the SP-AF 315. The procedure 300 ends.

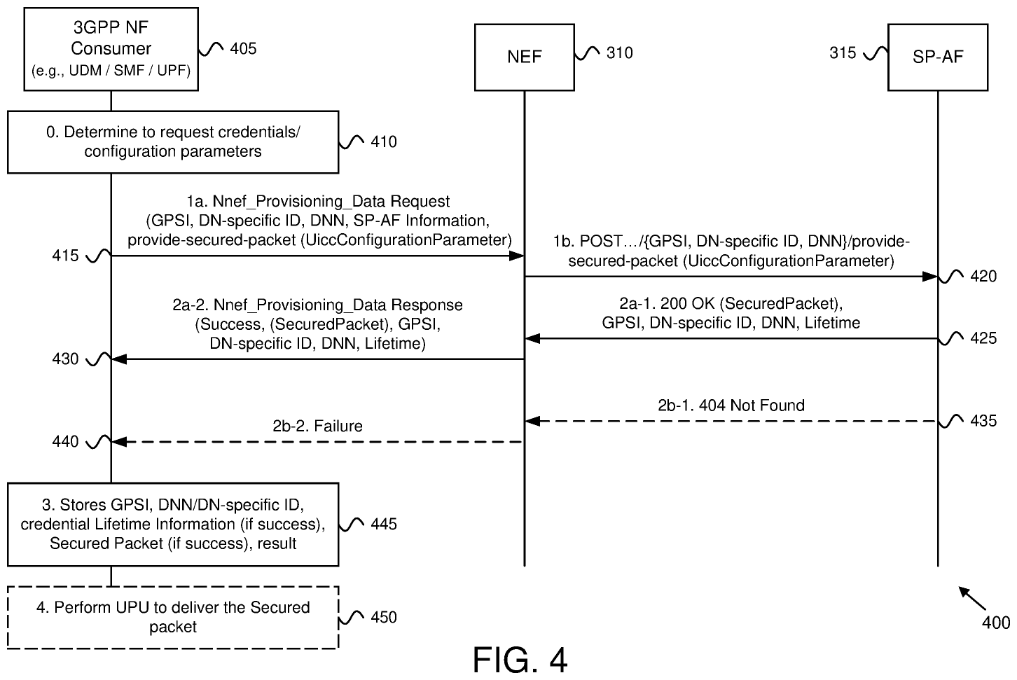

FIG. 4 depicts a procedure 400 for Secondary Authentication-based secure credential retrieval, according to embodiments of the disclosure. The procedure 400 is an example implementation of the first solution for Scenario-B. The procedure 400 involves a 3GPP NF consumer 405 (e.g., a UDM or SMF or UPF), the NEF 310, and the SP-AF 315. The steps shown in FIG. 4 are described as follows:

At Step 0, the 3GPP NF consumer 405 determines to request Secondary Authentication-related credentials/configuration parameter(s) for a UE 205 (see block 410). Here, the determination may be based on local policy, or based on expiry of network slice specific credentials corresponding to a S-NSSAI, a DN-specific ID, and/or a DNN, or based on expiry of DNN-specific credentials corresponding to a S-NSSAI, a DN-specific ID, and/or a DNN, or based on non-availability of network slice-specific credentials corresponding to a S-NSSAI, a DN-specific ID, and/or a DNN, or based on non-availability of DNN-specific credentials corresponding to a S-NSSAI, a DN-specific ID, and/or a DNN. Note that the DN-specific ID may be in NAI format.

At Step 1a, the 3GPP NF consumer 405 sends a Nnef_Provisioning_Data (or Nnef_ProvisioningData_Get) Request service operation message to the NEF 310 (see messaging 415). Here, the service operation message comprises at least a UE ID (e.g., GPSI), a Service-specific descriptor/information set (e.g., DN-specific ID and/or DNN and/or the DN's AAA server ID, if available), SP-AF information (e.g., SP-AF ID and/or address information of the SP-AF 315), and an indicator ‘provide-secured-packet’ comprising parameter UiccConfigurationParameter.

The purpose of the Service-specific information/descriptor is that it indicates the UDM and the SP-AF 315 that the content of the packet are the credentials/configuration parameter(s) related to the specific given service to be provisioned for the UE 205.

Alternatively, the message of Step 1a can also comprise ‘Data Type’ information element which is used by the 3GPP NF consumer 405 (e.g., UDM) to indicate to the SP-AF 315 what data (e.g., Routing ID, or SoR Data, or Network slice data, or any third-party service data, etc.) is required to be provisioned to the UDM as part of credentials (or configuration parameter(s)) from the SP-AF 315 for the UE 205. While FIG. 4 depicts the service operation message comprising a GPSI, in other embodiments the 3GPP NF consumer 405 may send a SUPI as the UE ID in Step 1a.

At Step 1b, upon receiving Step 1a, the NEF 310 sends a HTTP POST request message to the SP-AF 315 based on the received SP-AF ID/address information (see messaging 420). Here, the POST request comprises the UE ID (e.g., GPSI), the Service-specific descriptor/information set (e.g., DNN/DN-specific ID) and the UICC configuration parameter.

The NEF 310 sends the POST request (custom method: provide-secured-packet) to the resource representing the GPSI and DNN/DN-specific ID. Note that if the received message of Step 1a comprises a SUPI as the UE ID, then the NEF 310 translates the SUPI of the UE 205 into a GPSI corresponding to the UE 205. Here, the NEF 310 sends the GPSI of the UE 205 to the SP-AF 315 because the SP-AF 315 is not a trusted entity, therefore the 3GPP NF consumer 405 interacts with the SP-AF 315 via the NEF 310.

Upon receipt of Step 1b, either Step 2a-1 or Step 2b-1 is performed (e.g., based on success or failure).

At Step 2a-1, on success, the SP-AF 315 responds with a HTTP “200 OK” message (see messaging 425). Here, the HTTP “200 OK” message contains the requested Secured Packet, the UE ID (e.g., GPSI), the Service-specific descriptor/information set (e.g., DNN/DN-specific ID), and Lifetime information (corresponding to the validity of the secured packet or credentials in the secured packet). Alternatively, in Step 2a-1, the SP-AF 315 can also include an indication of whether the secured packet is to be stored in the ‘ME’ or ‘UICC.’

At Step 2b-1, if the resource does not exist (e.g., if the GPSI is unknown in the SP-AF 315), then the SP-AF 315 returns the HTTP status code “404 Not Found” (see messaging 435). In some embodiments, the HTTP “404 Not Found” message comprises a Failure indication, the UE ID (e.g., GPSI), the Service-specific descriptor/information set (e.g., DNN/DN-specific ID), and additional error information in the response body (e.g., in a “ProblemDetails” element). On failure, the appropriate HTTP status code indicating the error is returned and appropriate additional error information may be returned in the POST response body.

At Step 2a-2, if the NEF 310 receives “200 OK” message in Step 2a-1, then the NEF 310 sends a Nnef_Provisioining_Data Response service operation message to the 3GPP NF consumer 405 (see messaging 430). Here, the service operation message comprises a Success indication, the UE ID (e.g., GPSI), the Service-specific descriptor/information set (e.g., DNN/DN-specific ID), the Secured Packet, and the Lifetime information. Alternatively, if in Step 2a-1, the NEF 310 receives an indication whether the secured packet has to be stored in the ‘ME’ or ‘UICC’, then the NEF 310 sends the received indication in Nnef_Provisioining Data Response service operation message to the 3GPP NF consumer 405 along with the other information.

Step 2b-2, the NEF 310 if receives HTTP status code such as “404 Not Found” or an HTTP POST message comprising the failure case Step 2b-1, then the NEF 310 sends a Nnef_Provisioining_Data Response service operation message to the 3GPP NF consumer 405 (see messaging 440). Here, the service operation message comprises the Failure indication, the UE ID (e.g., GPSI), and the Service-specific descriptor/information set (e.g., DNN/DN-specific ID).

Note that if the received message of Step 1a comprises a SUPI as the UE ID, then the NEF 310 translates the GPSI in the received message of Step 2a-1 (success case) or Step 2b-1 (failure case) back to the SUPI corresponding to the UE 205.

At Step 3, the 3GPP NF consumer 405 stores (i.e., locally or in the UDR) the received UE ID (e.g., GPSI), the received Service-specific descriptor/information set (e.g., DNN/DN-specific ID), and a provisioning retrieval result (see block 445). Additionally, the 3GPP NF consumer 405 stores, as the result, either the Secured Packet and the credential lifetime information received in the success case (i.e., described in Step 2a-1 and Step 2a-2); or the failure indication received in the failure case (i.e., described in Step 2b-1 and Step 2b-2). Here, storing in the UDR may be based on the UE ID (e.g., GPSI). Note that in the above Scenario-B, Step 1 to Step 3 may also include the IP address and/or MAC address of the UE 205 allocated to the PDU Session.

At optional Step 4, if the 3GPP NF consumer 405 consumer receives, in Step 2a-1, an indication that the Secured Packet has to be stored in the ‘ME’ or ‘UICC’, then the 3GPP NF consumer 405 stores the received indication along with other data and uses this indication to determine if a UPU procedure is to be triggered to store the UPU data/secured packet in the ME or UICC of the UE 205 (see block 450). Here, the UDM may initiate the UPU procedure. Further, the UDM may also provide an indication (i.e., the indication that the secured packet has to be stored in the ‘ME’ or ‘UICC’) to the UE 205 along with the UPU data/secured packet during the UPU procedure to request the UE 205 to store the UPU data/secured packet in the ‘ME’ or the ‘UICC,’ as indicated by the SP-AF 315. The procedure 400 ends.

Moreover, in an alternative implementation of the first solution, Scenario-A (the procedure 300) and Scenario-B (the procedure 400) may be modified according to the below alternatives. In each alternative, alternative usage of service operation message between 3GPP NF consumer 305 or 3GPP NF consumer 405 (“3GPP NF consumer 305/405”) and the NEF 310 for Step 1a and Step 2a-2 of FIG. 3 and FIG. 4 are described.

Alternative 1—the 3GPP NF consumer 305/405 sends a HTTP POST message to the NEF 310, and the NEF 310 forwards the HTTP POST message to the SP-AF 315. In this alternative, at Step 1a (referring to messaging 325 in the above description of FIG. 3 or messaging 415 in the above description of FIG. 4), the 3GPP NF consumer 305/405 sends all information elements described for the respective Step 1a in a HTTP POST message to the NEF 310, and for the respective Step 1b the NEF 310 forwards the received POST message to the SP-AF 315. In Step 2a-2, the NEF 310 forwards the information received in the respective Step 2a-1 to the 3GPP NF consumer 305/405. The 3GPP NF consumer 305/405 and the NEF 310 can use any Nnef service operation message or can use HTTP POST request/response messages for supporting this Alternative 1.

Alternative 2—the 3GPP NF consumer 305/405 and the NEF 310 uses a Nnef_ServiceParameter service operation message to perform Create/Update/Get Secured packet Request/Response from the SP-AF 315 via the NEF 310. In this alternative, the Nnef_ServiceParameter service operation message may be used by the 3GPP NF consumer 305/405 to perform Step 1a and either Step 2a-2 or Step 2b-2, respectively.

For Alternative 2, the service operation message use following parameters: Inputs, Required=UE ID (e.g., GPSI), Secured Packet Indication (UICC Configuration Parameter Indication), Service-specific descriptor/information set (e.g., ENSI/SNSSAI, if for slice authentication, or DNN/DN-specific ID, if for Secondary Authentication), SP-AF ID/Address Information; Outputs, Required=Result (Success/Failure) Indication, Secured Packet (If Result is success), UE ID (e.g., GPSI), Service-specific descriptor/information set (e.g., ENSI/SNSSAI, if for slice authentication, or DNN/DN-specific ID, if for Secondary Authentication), Lifetime (if Result is success).

Alternative 3—the 3GPP NF consumer 305/405 and the NEF 310 uses Nnef_ParameterProvision service operation message to perform Create/Update/Get Secured packet Request/Response from the SP-AF 315 via the NEF 310. In this alternative, the Nnef_ParameterProvision service operation message can be used by the 3GPP NF consumer 305/405 to perform Step 1a and either Step 2a-2 or Step 2b-2, respectively.

For Alternative 3, the service operation message use following parameters: Inputs, Required=UE ID (e.g., GPSI), Secured Packet Indication (comprising UICC Configuration Parameter Indication), Service-specific descriptor/information set (e.g., ENSI/SNSSAI, if for slice authentication, or DNN/DN-specific ID, if for Secondary Authentication), SP-AF ID/Address Information; Outputs, Required=Result (Success/Failure) Indication, Secured Packet (If Result is success), UE ID (e.g., GPSI), Service-specific descriptor/information set (e.g., ENSI/SNSSAI, if for slice authentication, or DNN/DN-specific ID, if for Secondary Authentication), Lifetime (if Result is success).

Note that the first solution takes into account the following network function and application function terminology clarifications: the 3GPP NF consumer specified in this disclosure as the 3GPP NF consumer 305/405 may correspond to UDM, or a SoR-AF, or a NSSAAF, or a NEF, or a SMF, or a UPF, or any NF consumer. The SP-AF 315 specified in this disclosure may correspond to any AF, or application server, or AAA server, or Secured Packet Application Function. Also, instead of GPSI, any external UE ID may be used alternatively for the Secured packet retrieval procedure described in this embodiment. While the procedures 300 and 400 are used to retrieve/provision a Secured Packet, in other embodiments the steps of the procedures 300 and 400 may be used to deliver a different type of packet containing protected data and/or sensitive data.

Disclosed herein are embodiments of a second solution relating to enhancements to Secured Packet Retrieval procedure to support service-specific credential(s)/parameter(s) retrieval from a trusted AF (i.e., without involving the NEF 310). The second solution describes how a 3GPP NF consumer can request a service-specific provisioning and/or updating credentials/parameter(s), (i.e., during secured packet retrieval) from an application function or server corresponding to the service (i.e., network slice or data network) which is trusted by the 3GPP network and/or is located within the 3GPP network.

The second solution may include the following scenarios, C and D, respectively:

Scenario-C relates to NSSAA-related credentials Retrieval. Here, the NF consumer (e.g., UDM) sends S-NSSAI in an HTTP POST request (custom method: provide-secured-packet) to the resource representing the SUPI for the case when a Network Slice-specific credential/parameter needs to be fetched from the SP-AF. In Scenario-C the NF consumer receives the SUPI, S-NSSAI, Lifetime from the SP-AF.

Scenario-D relates to Secondary Authentication related credentials Retrieval. Here, the NF consumer (e.g., UDM) sends DN-specific ID and/or DNN in an HTTP POST request (custom method: provide-secured-packet) to the resource representing the SUPI for the case when a DNN-specific Secondary Authentication credential/parameter needs to be fetched from the SP-AF. In Scenario-D, the NF consumer receives the SUPI, DN-specific ID, DNN and Lifetime from the SP-AF.

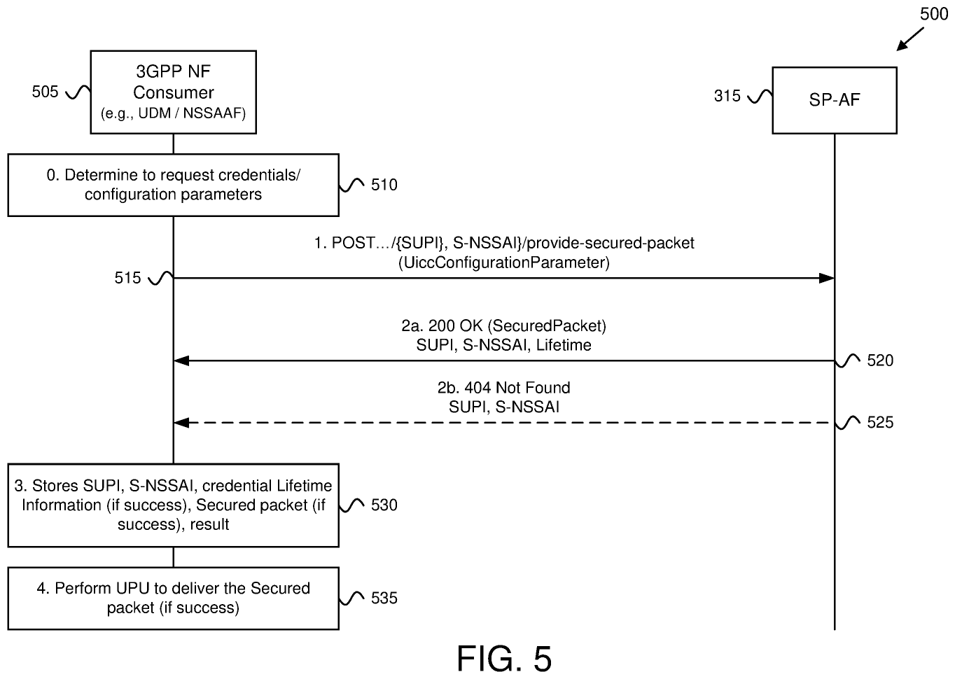

FIG. 5 depicts a procedure 500 for NSSAA-based secure credential retrieval, according to embodiments of the disclosure. The procedure 500 is an example implementation of the second solution for Scenario-C. The procedure 500 involves a NF-consumer 505 (e.g., a UDM or NSSAAF) and a SP-AF 315. The steps shown in FIG. 5 are described as follows:

At Step 0, the NF-consumer 505 determines to request NSSAA-related credentials/configuration parameter(s) for a UE 205 (see block 510). Here, the determination may be based on local policy, or based on expiry of third-party network slice credentials, or based on non-availability of third-party network slice credentials corresponding to an S-NSSAI.

At Step 1, the NF-consumer 505 sends a HTTP POST request message to the SP-AF 315 based on the received SP-AF ID/address information (see messaging 515). Here, the POST request comprises the UE ID (e.g., SUPI), a Service-specific descriptor/information set (e.g., S-NSSAI), and an indicator ‘provide-secured-packet’ comprising the UICC configuration parameter. The NF-consumer 505 sends the POST request (custom method: provide-secured-packet) to the resource representing the SUPI and the S-NSSAI. Here, the NF-consumer 505 sends the SUPI of the UE 205 to the SP-AF 315 because the SP-AF 315 is a trusted entity. The purpose of the Service-specific descriptor/information set is that it indicates to the NF-consumer 505 (e.g., UDM) and the SP-AF 315 that the contents of the packet are the credentials/configuration parameter(s) related to the specific given service to be provisioned for the UE 205.

Alternatively, the message of Step 1a may also comprise a ‘Data Type’ information element which is used by the NF-consumer 505 to indicate to the SP-AF 315 what data (e.g., Routing ID, or SoR Data, or Network slice data, or any third-party service data, etc.) is required to be provisioned to the UDM as part of credentials and/or configuration parameter(s) from the SP-AF 315 for the UE 205.

Upon receipt of Step 1, either Step 2a or Step 2b is performed (e.g., based on success or failure).

At Step 2a, on success, the SP-AF 315 responds with a HTTP “200 OK” message (see messaging 520). Here, the HTTP “200 OK” message contains the requested Secured Packet, the UE ID (e.g., SUPI), the Service-specific descriptor/information set (e.g., S-NSSAI), and Lifetime information (corresponding to the validity of the secured packet or of the credentials in the secured packet). Alternatively, in Step 2a, the SP-AF 315 can also include an indication of whether the secured packet is to be stored in the ‘ME’ or ‘UICC.’

At Step 2b, if the resource does not exist (e.g., the SUPI is unknown in the SP-AF 315), the SP-AF 315 returns the HTTP status code “404 Not Found” (see messaging 525). In some embodiments, the HTTP “404 Not Found” message comprises the UE ID (e.g., SUPI), Service-specific descriptor/information set (e.g., S-NSSAI), and additional error information in the response body (e.g., in a “ProblemDetails” element). On failure, the appropriate HTTP status code indicating the error is returned and appropriate additional error information may be returned in the POST response body.

At Step 3, the NF-consumer 505 stores (i.e., locally or in the UDR) the received UE ID (e.g., SUPI), the received Service-specific descriptor/information set (e.g., S-NSSAI), and a provisioning retrieval result (see block 530). Additionally, the NF-consumer 505 stores, as the result, either the Secured Packet and credential lifetime information received the in the success case (i.e., described in Step 2a); or the failure indication received in the failure case (i.e., described in Step 2b). Here, storing in the UDR may be based on the UE ID (e.g., SUPI).

At optional Step 4, if the NF-consumer 505 receives, in Step 2a, an indication that the secured packet has to be stored in the ‘ME’ or ‘UICC’, then the NF-consumer 505 stores the received indication along with other data and uses this indication to determine if a UPU procedure is to be triggered to store the UPU data/secured packet in ME or UICC of the UE 205 (see block 535). Here, the UDM may initiate the UPU procedure. Further, the UDM may also provide an indication (i.e., the indication that the secured packet has to be stored in the ‘ME’ or ‘UICC’) to the UE 205 along with the UPU data/secured packet during the UPU procedure to request the UE 205 to store the UPU data/secured packet in the ‘ME’ or the ‘UICC,’ as indicated by the SP-AF 315. The procedure 500 ends.

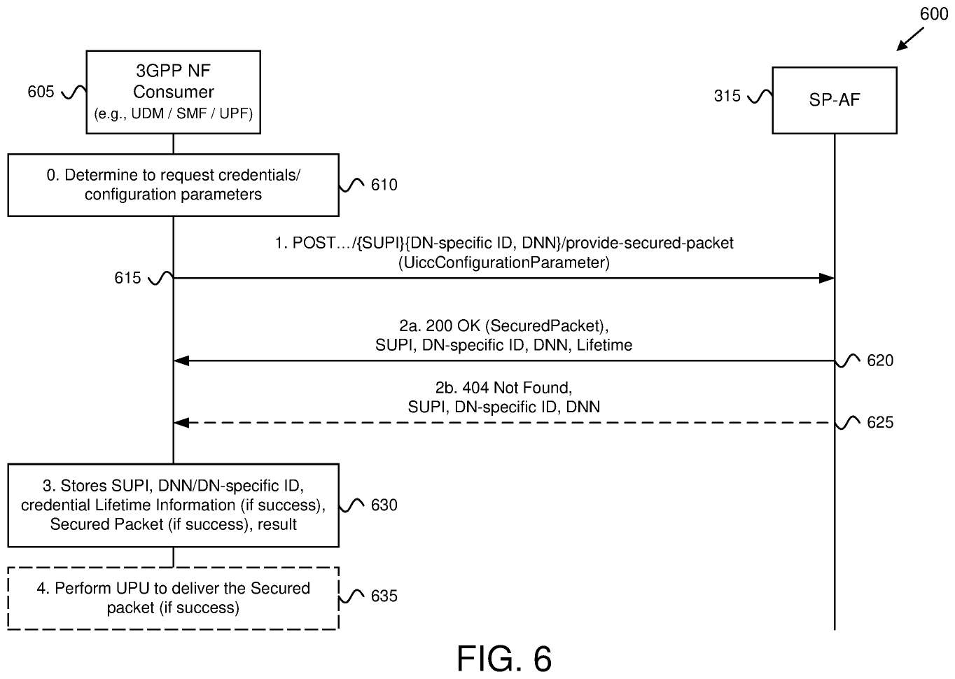

FIG. 6 depicts a procedure 600 for Secondary Authentication-based secure credential retrieval, according to embodiments of the disclosure. The procedure 600 is an example implementation of the first solution for Scenario-D. The procedure 600 involves a NF-consumer 605 (e.g., a UDM or SMF or UPF) and the SP-AF 315. The steps shown in FIG. 6 are described as follows:

At Step 0, the NF-consumer 605 determines to request Secondary Authentication-related credentials/configuration parameter(s) for a UE 205 (see block 610). Here, the determination may be based on local policy, or based on expiry of network slice specific credentials corresponding to a S-NSSAI, a DN-specific ID, and/or a DNN, or based on expiry of DNN-specific credentials corresponding to a S-NSSAI, a DN-specific ID, and/or a DNN, or based on non-availability of network slice-specific credentials corresponding to a S-NSSAI, a DN-specific ID, and/or a DNN, or based on non-availability of DNN-specific credentials corresponding to a S-NSSAI, a DN-specific ID, and/or a DNN. Note that the DN-specific ID may be in NAI format.

At Step 1, the NF-consumer 605 sends a HTTP POST request message to the SP-AF 315 based on the received SP-AF ID/address information (see messaging 615). Here, the POST request comprises the UE ID (e.g., SUPI), the Service-specific descriptor/information set (e.g., DNN/DN-specific ID) and the UICC configuration parameter. The NF-consumer 605 sends the POST request (custom method: provide-secured-packet) to the resource representing the SUPI and DNN/DN-specific ID. The purpose of the Service-specific information/descriptor is that it indicates the UDM and the SP-AF 315 that the content of the packet are the credentials/configuration parameter(s) related to the specific given service to be provisioned for the UE 205.

Alternatively, the message of Step 1a may also comprise ‘Data Type’ information element which is used by the NF-consumer 605 (to indicate the SP-AF 315 that what data (e.g., Routing ID, or SoR Data, or Network slice data, or any third-party service data, etc.) is required to be provisioned to the UDM as part of credentials and/or configuration parameter(s) from the SP-AF 315 for the UE 205.

Upon receipt of Step 1b, either Step 2a or Step 2b is performed (e.g., based on success or failure).

At Step 2a, on success, the SP-AF 315 responds with a HTTP “200 OK” message (see messaging 620). Here, the HTTP “200 OK” message contains the requested Secured Packet, the UE ID (e.g., SUPI), the Service-specific descriptor/information set (e.g., DNN/DN-specific ID), and Lifetime information (corresponding to the validity of the secured packet or credentials in the secured packet). Alternatively, in Step 2a, the SP-AF 315 can also include an indication of whether the secured packet is to be stored in the ‘ME’ or ‘UICC.’

At Step 2b, if the resource does not exist (e.g., the SUPI is unknown in the SP-AF 315), the SP-AF 315 returns the HTTP status code “404 Not Found” (see messaging 625). In some embodiments, the with HTTP “404 Not Found” message comprises the UE ID (e.g., SUPI), the Service-specific descriptor/information set (e.g., DNN/DN-specific ID), and additional error information in the response body (e.g., in a “ProblemDetails” element). On failure, the appropriate HTTP status code indicating the error is returned and appropriate additional error information may be returned in the POST response body.

At Step 3, the NF-consumer 605 stores (i.e., locally or in the UDR) the UE ID (e.g., SUPI), the received Service-specific descriptor/information set (e.g., DNN/DN-specific ID), and a provisioning retrieval result (see block 630). Additionally, the NF-consumer 605 stores, as the result, either the Secured Packet and the credential lifetime information received in the success case (i.e., described in Step 2a); or stores the failure indication received in the failure case (i.e., described in Step 2b). Here, storing in the UDR may be based on the UE ID (e.g., SUPI). Note that in the above Scenario-D, Step 1 to Step 3 may also include the IP and/or MAC address of the UE 205 allocated to the PDU Session.

At optional Step 4, if the NF-consumer 605 receives in Step 2a, an indication that the Secured Packet has to be stored in the ‘ME’ or ‘UICC’, then the NF-consumer 605 stores the received indication along with other data and uses this indication to determine if a UPU procedure is to be triggered to store the UPU data/secured packet in ME or UICC of the UE 205 (see block 635). Here, the UDM may initiate the UPU procedure. Further, the UDM may also provide an indication (i.e., the indication that the secured packet has to be stored in the ‘ME’ or ‘UICC’) to the UE 205 along with the UPU data/secured packet during the UPU procedure to request the UE 205 to store the UPU data/secured packet in the ‘ME’ or the ‘UICC,’ as indicated by the SP-AF 315. The procedure 600 ends.

Note that the second solution takes into account the following network function and application function terminology clarifications: the 3GPP NF consumer specified in this disclosure as NF-consumer 505 or NF-consumer 605 can correspond to a UDM, or a SoR-AF, or a NSSAAF, or a NEF, or a SMF, or a UPF, or any NF consumer. The SP-AF 315 specified in this disclosure can correspond to any AF, or application server, or AAA server, or Secured Packet Application Function. While the procedures 500 and 600 are used to retrieve/provision a Secured Packet, in other embodiments the steps of the procedures 500 and 600 may be used to deliver a different type of packet containing protected data and/or sensitive data.

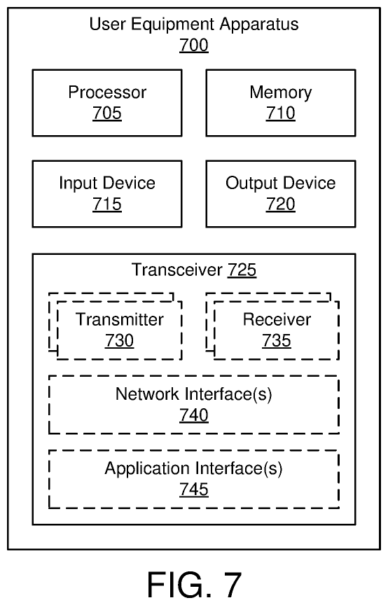

FIG. 7 depicts a user equipment apparatus 700 that may be used for provisioning a Secured Packet, according to embodiments of the disclosure. In various embodiments, the user equipment apparatus 700 is used to implement one or more of the solutions described above. The user equipment apparatus 700 may be one embodiment of a user endpoint, such as the remote unit 105 and/or the UE 205, as described above. Furthermore, the user equipment apparatus 700 may include a processor 705, a memory 710, an input device 715, an output device 720, and a transceiver 725.

In some embodiments, the input device 715 and the output device 720 are combined into a single device, such as a touchscreen. In certain embodiments, the user equipment apparatus 700 may not include any input device 715 and/or output device 720. In various embodiments, the user equipment apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. In some embodiments, the transceiver 725 communicates with one or more cells (or wireless coverage areas) supported by one or more base units 121. In various embodiments, the transceiver 725 is operable on unlicensed spectrum. Moreover, the transceiver 725 may include multiple UE panels supporting one or more beams. Additionally, the transceiver 725 may support at least one network interface 740 and/or application interface 745. The application interface(s) 745 may support one or more APIs. The network interface(s) 740 may support 3GPP reference points, such as Uu, N1, PC5, etc. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the processor 705 controls the user equipment apparatus 700 to implement the above-described UE behaviors. In certain embodiments, the processor 705 may include an application processor (also known as “main processor”) which manages application-domain and operating system (“OS”) functions and a baseband processor (also known as “baseband radio processor”) which manages radio functions.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to provisioning a Secured Packet. For example, the memory 710 may store various parameters, panel/beam configurations, resource assignments, policies, and the like as described above. In certain embodiments, the memory 710 also stores program code and related data, such as an operating system or other controller algorithms operating on the user equipment apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 720 may include a wearable display separate from, but communicatively coupled to, the rest of the user equipment apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 communicates with one or more network functions of a mobile communication network via one or more access networks. The transceiver 725 operates under the control of the processor 705 to transmit messages, data, and other signals and also to receive messages, data, and other signals. For example, the processor 705 may selectively activate the transceiver 725 (or portions thereof) at particular times in order to send and receive messages.

The transceiver 725 includes at least transmitter 730 and at least one receiver 735. One or more transmitters 730 may be used to provide UL communication signals to a base unit 121, such as the UL transmissions described herein. Similarly, one or more receivers 735 may be used to receive DL communication signals from the base unit 121, as described herein. Although only one transmitter 730 and one receiver 735 are illustrated, the user equipment apparatus 700 may have any suitable number of transmitters 730 and receivers 735. Further, the transmitter(s) 730 and the receiver(s) 735 may be any suitable type of transmitters and receivers. In one embodiment, the transceiver 725 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example, a single chip performing functions for use with both licensed and unlicensed radio spectrum. In some embodiments, the first transmitter/receiver pair and the second transmitter/receiver pair may share one or more hardware components. For example, certain transceivers 725, transmitters 730, and receivers 735 may be implemented as physically separate components that access a shared hardware resource and/or software resource, such as for example, the network interface 740.

In various embodiments, one or more transmitters 730 and/or one or more receivers 735 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 730 and/or one or more receivers 735 may be implemented and/or integrated into a multi-chip module. In some embodiments, other components such as the network interface 740 or other hardware components/circuits may be integrated with any number of transmitters 730 and/or receivers 735 into a single chip. In such embodiment, the transmitters 730 and receivers 735 may be logically configured as a transceiver 725 that uses one more common control signals or as modular transmitters 730 and receivers 735 implemented in the same hardware chip or in a multi-chip module.

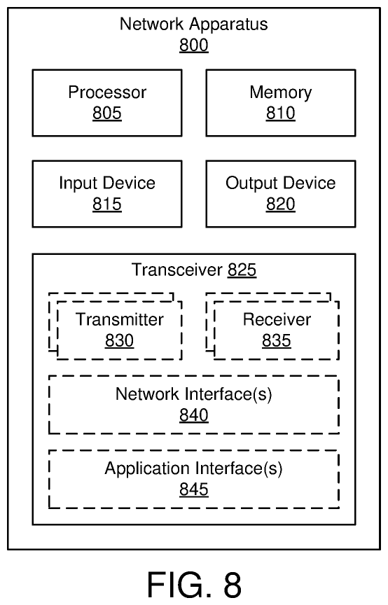

FIG. 8 depicts a network apparatus 800 that may be used for provisioning a Secured Packet, according to embodiments of the disclosure. In one embodiment, the network apparatus 800 may be one implementation of a network endpoint, such as the base unit 121 and/or

RAN node 210, as described above. In another embodiment, the network apparatus 800 may be one implementation of a consumer NF, such as a UDM, a NSSAAF, a SMF, a UPF, or another NF that interacts with a SP-AF. In a further embodiment, the network apparatus 800 may be one implementation of a SP-AF, such as the AF 146, the SP-AF 315, or another AF that interacts with a consumer NF. In other embodiments, the network apparatus 800 may be one implementation of an NEF that interacts with a consumer NF and a SP-AF. Furthermore, the network apparatus 800 may include a processor 805, a memory 810, an input device 815, an output device 820, and a transceiver 825.

In some embodiments, the input device 815 and the output device 820 are combined into a single device, such as a touchscreen. In certain embodiments, the network apparatus 800 may not include any input device 815 and/or output device 820. In various embodiments, the network apparatus 800 may include one or more of: the processor 805, the memory 810, and the transceiver 825, and may not include the input device 815 and/or the output device 820. As depicted, the transceiver 825 includes at least one transmitter 830 and at least

one receiver 835. Here, the transceiver 825 communicates with one or more remote units 105. Additionally, the transceiver 825 may support at least one network interface 840 and/or application interface 845. The application interface(s) 845 may support one or more APIs. The network interface(s) 840 may support 3GPP reference points, such as Uu, N1, N2 and N3. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a CPU, a GPU, an auxiliary processing unit, a FPGA, or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825.

In various embodiments, the network apparatus 800 is a RAN node (e.g., gNB) that communicates with one or more UEs, as described herein. In such embodiments, the processor 805 controls the network apparatus 800 to perform the above-described RAN behaviors. When operating as a RAN node, the processor 805 may include an application processor (also known as “main processor”) which manages application-domain and operating system (“OS”) functions and a baseband processor (also known as “baseband radio processor”) which manages radio functions.

In various embodiments, the processor 805 controls the network apparatus 800 to implement the above-described consumer NF behavior. In such embodiments, the network apparatus 800 may be a UDM, a NSSAAF, a SMF, a UPF, or another consumer NF that interacts with a SP-AF. Note that such interactions may or may not involve a NEF.

Via the transceiver 825, the processor 805 sends, to the SP-AF, a request for a credential related to a device (i.e., a UE identified by subscriber identity) and a service descriptor. In some embodiments, sending the request for the credential includes invoking a Secured Packet Request. In such embodiments, the processor 805 may determine to invoke the Secured Packet Request based on: a local policy, a lifetime of a credential, a non-availability of a credential, or a combination thereof.

In some embodiments, to send the request for the credential, the processor 805 controls the transceiver 825 to send the request via a NEF. In such embodiments, the processor 805 may send the request by invoking a Nnef service operation, where the request for the credential includes: an identifier of the SP-AF, network address information of the SP-AF, or a combination thereof. In other embodiments, to send the request for the credential, the processor 805 controls the transceiver 825 to send a HTTP POST request message.

Via the transceiver 825, the processor 805 receives a secured packet and credential information from the SP-AF. Here, the credential information may include: a subscriber identity corresponding to the device (e.g., SUPI/GPSI), a lifetime for the Secured Packet, a network service identifier (e.g., ENSI/S-NSSAI or DNN/DN-specific ID), a device storage requirement indication (e.g., storage on ME/UICC), or a combination thereof. In such embodiments, to receive the secured packet and the credential information, the processor 805 receives a HTTP 200 OK message via the transceiver 825.

The processor 805 stores (e.g., in the UDR) the secured packet and the credential information, the secured packet including the valid credential. In some embodiments, the secured packet contains one or more credentials for slice-specific authentication of the device. In other embodiments, the secured packet contains one or more credentials for Secondary Authentication of the device. Additionally, via the transceiver 825, the processor 805 provisions the secured packet to the device via an update procedure, e.g., using a UE Parameters Update procedure. The provisioning via UE Parameters Update procedure may be as defined in clause 4.20 of 3GPP TS 23.502.

In some embodiments, the requested credential includes a credential for NSSAA. Here, to send the request for the credential for NSSAA, the processor 805 controls the transceiver 825 to send a HTTP POST Request to the SP-AF, where the HTTP POST Request includes a network slice identifier (e.g., ENSI or S-NSSAI). In such embodiments, the credential information may include the network slice identifier (e.g., ENSI or S-NSSAI).

In some embodiments, the requested credential includes a credential for Secondary Authentication. Here, to send the request for the credential for Secondary Authentication, the processor 805 controls the transceiver 825 to send a HTTP POST Request to the SP-AF, where the HTTP POST Request includes: a DN-specific ID, a DNN, or a combination thereof. In such embodiments, the credential information may include the DN-specific ID and/or DNN.

In some embodiments, the subscriber identity includes a GPSI corresponding to the device. In certain embodiments, the subscriber identity further includes at least one of: an IPV4 address, an IPv6 address, an International Mobile Equipment Identity (“IMEI”), an IPv4v6 address, a MAC address, or a combination thereof.

In some embodiments, the subscriber identity includes a SUPI corresponding to the device. In certain embodiments, the subscriber identity further includes at least one of: an IPV4 address, an IPV6 address, an IMEI, an IPV4v6 address, a MAC address, or a combination thereof.

In some embodiments, the service descriptor includes: external network slice information, single network slice selection assistance information, a network access identifier, a data network specific identifier, a data network name, an identity of an AAA server, or a combination thereof.

In various embodiments, the processor 805 controls the network apparatus 800 to implement the above-described SP-AF behavior. In such embodiments, the network apparatus 800 may be a SP-AF that interacts with a network function, such as a NEF or consumer NF.

Via the transceiver 825, the processor 805 receives, from the network function, a request for a credential related to a device (i.e., a UE identified by subscriber identity) and a service descriptor. In some embodiments, the request for the credential includes a Secured Packet Request. In such embodiments, the Secured Packet Request may be contained within a HTTP POST request.

In some embodiments, the requested credential includes a credential for NSSAA, where, to receive the request for the credential for NSSAA, the processor is configured to cause the apparatus to receive, from the network function, a HTTP POST Request including a network slice identifier (e.g., ENSI or S-NSSAI). In such embodiments, the credential information may include the network slice identifier (e.g., ENSI or S-NSSAI).

In some embodiments, the requested credential includes a credential for Secondary Authentication, where, to receive the request for the credential for Secondary Authentication, the processor is configured to cause the apparatus to receive, from the network function, a HTTP POST Request including: a DN-specific ID, a DNN, or a combination thereof. In such embodiments, the credential information may include the DN-specific ID and/or DNN.

The processor 805 determines whether a valid credential exists for the device and the service descriptor. If the processor 805 determines that a valid credential does not exist for the device and the service descriptor, then the processor 805 controls the transceiver 825 to send a failure indication to the network function. In some embodiments, the failure indication includes a 404 Not Found message or a HTTP POST response message.

The processor 805 generates a secured packet in response to determining that the valid credential exists for the device and the service descriptor. In some embodiments, the secured packet contains one or more credentials for slice-specific authentication of the device. In other embodiments, the secured packet contains one or more credentials for Secondary Authentication of the device.

Via the transceiver 825, the processor 805 sends the secured packet and credential information to the network function. Here, the credential information may include: a subscriber identity corresponding to the device (e.g., SUPI/GPSI), a lifetime for the Secured Packet, a network service identifier (e.g., ENSI/S-NSSAI or DNN/DN-specific ID), a device storage requirement indication (e.g., storage on ME/UICC), or a combination thereof.

In some embodiments, to send the secured packet and credential information, the processor is configured to cause the apparatus to send a 200 OK message. In some embodiments, to send the secured packet and the credential information, the processor is configured to cause the apparatus to send a success indication indicating availability of a secured packet. In certain embodiments, the secured packet may include at least one credential for the subscriber identity and the service descriptor.

In various embodiments, the service descriptor includes: external network slice information, single network slice selection assistance information, a network access identifier, a data network specific identifier, a data network name, an identity of an AAA server, or a combination thereof.

In some embodiments, the subscriber identity includes a GPSI corresponding to the device. In certain embodiments, the subscriber identity further includes at least one of: an IPV4 address, an IPV6 address, an IMEI, an IPV4v6 address, a MAC address, or a combination thereof. In certain embodiments, the request for the credential is received via a NEF.

In some embodiments, the subscriber identity includes a SUPI corresponding to the device. In certain embodiments, the subscriber identity further includes at least one of: an IPV4 address, an IPV6 address, an IMEI, an IPV4v6 address, a MAC address, or a combination thereof.

In various embodiments, the processor 805 controls the network apparatus 800 to implement the above-described NEF behavior. In such embodiments, the network apparatus 800 may be a NEF that interacts with a consumer NF and a SP-AF.

Via the transceiver 825, the processor 805 receives, from the consumer NF, a first request message for a credential related to a device (i.e., a UE identified by subscriber identity) and a service descriptor, where the first request message includes a destination address. Via the transceiver 825, the processor 805 sends, to the SP-AF using the destination address, a second request message for the credential related to the device and the service descriptor.

In some embodiments, the first and second request messages each include a Secured Packet Request. In some embodiments, the first request message includes: an identifier of the SP-AF, network address information of the SP-AF, or a combination thereof. In various embodiments, the service descriptor includes: external network slice information, single network slice selection assistance information, a network access identifier, a data network specific identifier, a data network name, an identity of an AAA server, or a combination thereof.

Via the transceiver 825, the processor 805 receives, from the SP-AF, a first response message including a secured packet (e.g., containing a credential related to the device and the service descriptor) and credential information, the credential information including: a subscriber identity corresponding to the device (e.g., SUPI/GPSI), a lifetime for the Secured Packet, a network service identifier (e.g., ENSI/S-NSSAI or DNN/DN-specific ID), a device storage requirement indication (e.g., storage on ME/UICC), or a combination thereof.

Via the transceiver 825, the processor 805 sends, to the consumer NF, a second response message including the secured packet and the credential information. In some embodiments, the secured packet contains one or more credentials for slice-specific authentication of the device. In other embodiments, the secured packet contains one or more credentials for secondary authentication of the device. In some embodiments, the first response message and the second response message each include a success indication indicating availability of a secured packet, where the secured packet includes at least one credential for the subscriber identity and the service descriptor.

In some embodiments, the first request message and the second response message each include a SUPI corresponding to the device. In such embodiments, the processor is further configured to cause the apparatus to translate the SUPI to a GPSI corresponding to the device, where the second request message and first response message each include the GPSI.

In certain embodiments, the first request message and second response message each contain a subscriber identity included of the SUPI and at least one of: an IPV4 address, an IPv6 address, an IMEI, an IPV4v6 address, a MAC address, or a combination thereof. In certain embodiments, the second request message and first response message each contain a subscriber identity included of the GPSI and at least one of: an IPV4 address, an IPV6 address, an IMEI, an IPv4v6 address, a MAC address, or a combination thereof.

In various embodiments, the first request message invokes a Nnef service operation, the second request message includes a HTTP POST request message. In some embodiments, the first response message includes a 200 OK message, and the second response message includes a success indication. In other embodiments, the first response message includes a 404 Not Found message or a HTTP POST response message, and the second response message includes a failure indication.

In some embodiments, the credential related to the device and the service descriptor includes a credential for NSSAA, where the first and second request messages each include a network slice identifier (e.g., ENSI or S-NSSAI). In such embodiments, the credential information may include the network slice identifier (e.g., ENSI or S-NSSAI).

In some embodiments, the credential related to the device and the service descriptor includes a credential for Secondary Authentication, where the first and second request messages include: a DN-specific ID, a DNN, or a combination thereof. In such embodiments, the credential information may include the DN-specific ID and/or DNN.

The memory 810, in one embodiment, is a computer readable storage medium. In some embodiments, the memory 810 includes volatile computer storage media. For example, the memory 810 may include a RAM, including DRAM, SDRAM, and/or SRAM. In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to provisioning a Secured Packet. For example, the memory 810 may store parameters, configurations, resource assignments, policies, and the like, as described above. In certain embodiments, the memory 810 also stores program code and related data, such as an operating system or other controller algorithms operating on the network apparatus 800.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, an LCD display, an LED display, an OLED display, a projector, or similar display device capable of outputting images, text, or the like to a user. As another, non-limiting, example, the output device 820 may include a wearable display separate from, but communicatively coupled to, the rest of the network apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, the output device 820 may be located near the input device 815.

The transceiver 825 includes at least transmitter 830 and at least one receiver 835. One or more transmitters 830 may be used to communicate with the UE, as described herein. Similarly, one or more receivers 835 may be used to communicate with network functions in the PLMN and/or RAN, as described herein. Although only one transmitter 830 and one receiver 835 are illustrated, the network apparatus 800 may have any suitable number of transmitters 830 and receivers 835. Further, the transmitter(s) 830 and the receiver(s) 835 may be any suitable type of transmitters and receivers.

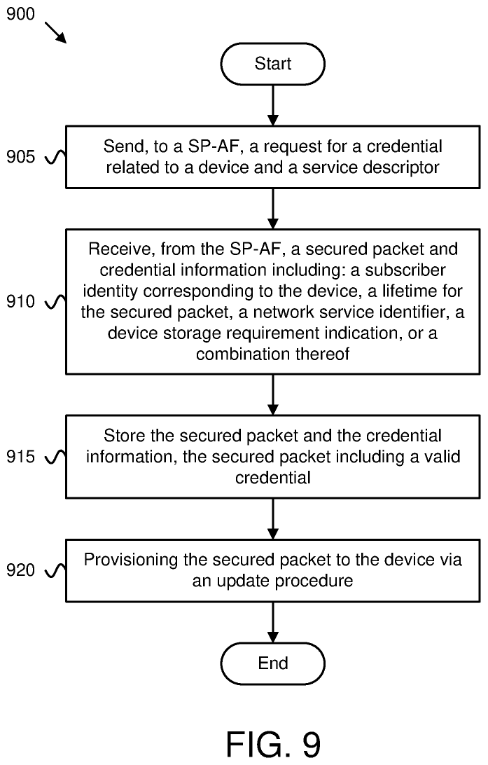

FIG. 9 depicts one embodiment of a method 900 for provisioning a Secured Packet, according to embodiments of the disclosure. In various embodiments, the method 900 is performed by a consumer NF, such as a UPF 141, a SMF 143, a NEF 145, a NSSAAF 147, a UDM/UDR 149, a 3GPP NF consumer 305, a 3GPP NF consumer 405, a NF-consumer 505, a NF-consumer 605, and/or the network apparatus 800, described above. In some embodiments, the method 900 is performed by a processor, such as a microcontroller, a microprocessor, a CPU, a GPU, an auxiliary processing unit, a FPGA, or the like.

The method 900 includes sending 905, to a SP-AF, a request for a credential related to a device and a service descriptor. The method 900 includes receiving 910, from the SP-AF, a secured packet and credential information including: a subscriber identity corresponding to the device, a lifetime for the secured packet, a network service identifier, a device storage requirement indication, or a combination thereof. The method 900 includes storing 915 the secured packet and the credential information, the secured packet including a valid credential. The method 900 includes provisioning 920 the secured packet to the device via an update procedure. The method 900 ends.

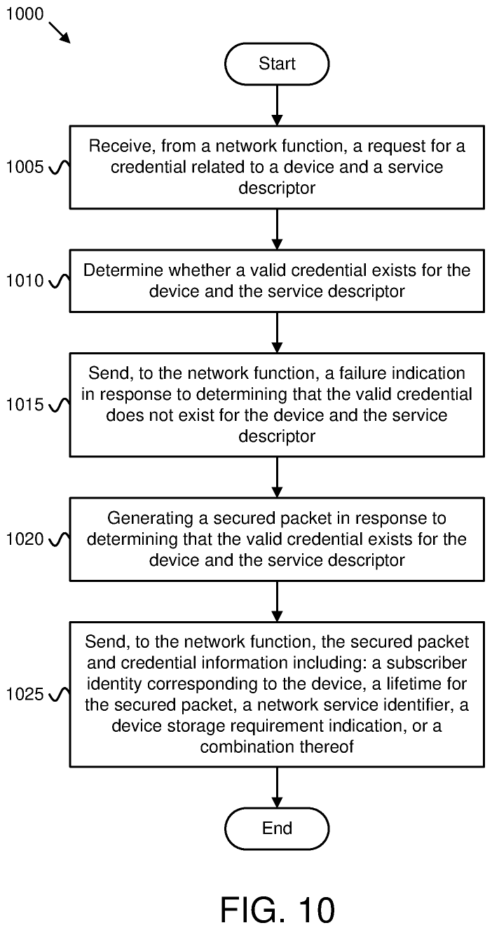

FIG. 10 depicts one embodiment of a method 1000 for provisioning a Secured Packet, according to embodiments of the disclosure. In various embodiments, the method 1000 is performed by an application function, such as the AF 146, the SP-AF 315, and/or the network apparatus 800, as described above. In some embodiments, the method 1000 is performed by a processor, such as a microcontroller, a microprocessor, a CPU, a GPU, an auxiliary processing unit, a FPGA, or the like.

The method 1000 includes receiving 1005, from a network function (e.g., NEF or consumer NF), a request for a credential related to a device and a service descriptor. The method 1000 includes determining 1010 whether a valid credential exists for the device and the service descriptor. The method 1000 includes sending 1015, to the network function, a failure indication in response to determining that the valid credential does not exist for the device and the service descriptor. The method 1000 includes generating 1020 a secured packet in response to determining that the valid credential exists for the device and the service descriptor. The method 1000 includes sending 1025, to the network function, the secured packet and credential information including: a subscriber identity corresponding to the device, a lifetime for the secured packet, a network service identifier, a device storage requirement indication, or a combination thereof. The method 1000 ends.

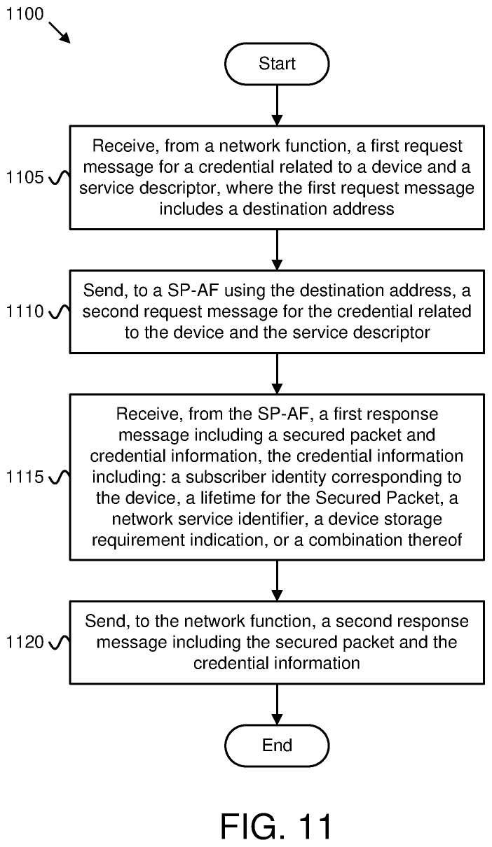

FIG. 11 depicts one embodiment of a method 1100 for provisioning a Secured Packet, according to embodiments of the disclosure. In various embodiments, the method 1100 is performed by a network device, such as the NEF 145, the NEF 310, and/or the network apparatus 800, as described above. In some embodiments, the method 1100 is performed by a processor, such as a microcontroller, a microprocessor, a CPU, a GPU, an auxiliary processing unit, a FPGA, or the like.

The method 1100 includes receiving 1105, from a network function, a first request message for a credential related to a device and a service descriptor, where the first request message includes a destination address. The method 1100 includes sending 1110, to a SP-AF using the destination address, a second request message for the credential related to the device and the service descriptor. The method 1100 includes receiving 1115, from the SP-AF, a first response message including a secured packet and credential information, the credential information including: a subscriber identity corresponding to the device, a lifetime for the Secured Packet, a network service identifier, a device storage requirement indication, or a combination thereof. The method 1100 includes sending 1120, to the network function, a second response message including the secured packet and the credential information. The method 1100 ends.

Disclosed herein is a first apparatus for provisioning a Secured Packet, according to embodiments of the disclosure. The first apparatus may be implemented by a consumer NF, such as a UPF 141, a SMF 143, a NEF 145, a NSSAAF 147, a UDM/UDR 149, a 3GPP NF consumer 305, a 3GPP NF consumer 405, a NF-consumer 505, a NF-consumer 605, and/or the network apparatus 800, described above. The first apparatus includes a processor coupled to a transceiver, the transceiver configured to communicate with a mobile communication network and the processor configured to cause the apparatus to: A) send, to a SP-AF, a request for a credential related to a device (i.e., a UE identified by subscriber identity) and a service descriptor; B) receive, from the SP-AF, a secured packet and credential information including: a subscriber identity corresponding to the device (e.g., SUPI/GPSI), a lifetime for the Secured Packet, a network service identifier (e.g., ENSI/S-NSSAI or DNN/DN-specific ID), a device storage requirement indication (e.g., storage on ME/UICC), or a combination thereof; C) store (e.g., in the UDR) the secured packet and the credential information, the secured packet including the valid credential; and D) provision the secured packet to the device via an update procedure (e.g., a UE Parameters Update procedure).

In some embodiments, to send the request for the credential, the processor is configured to cause the apparatus to invoke a Secured Packet Request. In some embodiments, the processor is further configured to cause the apparatus to determine to invoke the Secured Packet Request based on: a local policy, a lifetime of a credential, a non-availability of a credential, or a combination thereof.

In some embodiments, the secured packet contains one or more credentials for slice-specific authentication of the device. In other embodiments, the secured packet contains one or more credentials for secondary authentication of the device.

In some embodiments, the requested credential includes a credential for NSSAA, where, to send the request for the credential for NSSAA, the processor is configured to cause the apparatus to send, to the SP-AF, a HTTP POST Request including a network slice identifier (e.g., ENSI or S-NSSAI). In such embodiments, the credential information may include the network slice identifier (e.g., ENSI or S-NSSAI).

In some embodiments, the requested credential includes a credential for Secondary Authentication, where, to send the request for the credential for Secondary Authentication, the processor is configured to cause the apparatus to send, to the SP-AF, a HTTP POST Request including: a DN-specific ID, a DNN, or a combination thereof. In such embodiments, the credential information may include the DN-specific ID and/or DNN.

In some embodiments, to send the request for the credential, the processor is configured to cause the apparatus to send a HTTP POST request message. In such embodiments, to receive the secured packet and the credential information, the processor is configured to cause the apparatus to receive a HTTP 200 OK message.

In some embodiments, to send the request for the credential, the processor is configured to cause the apparatus to send the request via a NEF. In certain embodiments, to send the request for the credential, the processor is configured to cause the apparatus to invoke a Nnef service operation, where the request for the credential includes: an identifier of the SP-AF, network address information of the SP-AF, or a combination thereof.

In some embodiments, the subscriber identity includes a GPSI corresponding to the device. In certain embodiments, the subscriber identity further includes at least one of: an IPV4 address, an IPV6 address, an IMEI, an IPV4v6 address, a MAC address, or a combination thereof.

In some embodiments, the subscriber identity includes a SUPI corresponding to the device. In certain embodiments, the subscriber identity further includes at least one of: an IPV4 address, an IPV6 address, an IMEI, an IPV4v6 address, a MAC address, or a combination thereof.

In some embodiments, the service descriptor includes: external network slice information, single network slice selection assistance information, a network access identifier, a data network specific identifier, a data network name, an identity of an AAA server, or a combination thereof.

Disclosed herein is a first method for provisioning a Secured Packet, according to embodiments of the disclosure. The first method may be performed by a consumer NF, such as a UPF 141, a SMF 143, a NEF 145, a NSSAAF 147, a UDM/UDR 149, a 3GPP NF consumer 305, a 3GPP NF consumer 405, a NF-consumer 505, a NF-consumer 605, and/or the network apparatus 800, described above. The first method includes sending, to a SP-AF, a request for a credential related to a device (i.e., a UE identified by subscriber identity) and a service descriptor. The first method includes receiving, from the SP-AF, a secured packet and credential information including: a subscriber identity corresponding to the device (e.g., SUPI/GPSI), a lifetime for the secured packet, a network service identifier (e.g., ENSI/S-NSSAI or DNN/DN-specific ID), a device storage requirement indication (e.g., storage on ME/UICC), or a combination thereof. The first method includes storing (e.g., in the UDR) the secured packet and the credential information, the secured packet including a valid credential and provisioning the secured packet to the device via an update procedure (e.g., a UE Parameters Update procedure).

In some embodiments, sending the request for the credential includes invoking a Secured Packet Request. In such embodiments, the first method further includes determining to invoke the Secured Packet Request based on: a local policy, a lifetime of a credential, a non-availability of a credential, or a combination thereof.

In some embodiments, the secured packet contains one or more credentials for slice-specific authentication of the device. In other embodiments, the secured packet contains one or more credentials for secondary authentication of the device.

In some embodiments, the requested credential includes a credential for NSSAA, wherein sending the request for the credential for NSSAA includes sending, to the SP-AF, a HTTP

POST Request including a network slice identifier (e.g., ENSI or S-NSSAI). In such embodiments, the credential information may include the network slice identifier (e.g., ENSI or S-NSSAI).

In some embodiments, the requested credential includes a credential for Secondary Authentication, wherein sending the request for the credential for Secondary Authentication includes sending, to the SP-AF, a HTTP POST Request including: a DN-specific ID, a DNN, or a combination thereof. In such embodiments, the credential information may include the DN-specific ID and/or DNN.

In some embodiments, sending the request for the credential includes sending a HTTP POST request message. In such embodiments, receiving the secured packet and the credential information includes receiving a HTTP 200 OK message.

In some embodiments, sending the request for the credential includes sending via a NEF. In certain embodiments, sending the request for the credential includes invoking a Nnef service operation, where the request for the credential includes: an identifier of the SP-AF, network address information of the SP-AF, or a combination thereof.

In some embodiments, the subscriber identity includes a GPSI corresponding to the device. In certain embodiments, the subscriber identity further includes at least one of: an IPV4 address, an IPV6 address, an IMEI, an IPV4v6 address, a MAC address, or a combination thereof.

In some embodiments, the subscriber identity includes a SUPI corresponding to the device. In certain embodiments, the subscriber identity further includes at least one of: an IPV4 address, an IPV6 address, an IMEI, an IPV4v6 address, a MAC address, or a combination thereof.

The method of claim 1, wherein the service descriptor includes: external network slice information, single network slice selection assistance information, a network access identifier, a data network specific identifier, a data network name, an identity of an AAA server, or a combination thereof.

Disclosed herein is a third apparatus for provisioning a Secured Packet, according to embodiments of the disclosure. The third apparatus may be implemented by an application function, such as the AF 146, the SP-AF 315, and/or the network apparatus 800, as described above. The third apparatus includes a processor coupled to a transceiver configured to communicate with a network function (e.g., NEF or consumer NF), where the processor is configured to cause the apparatus to: A) receive, from the network function, a request for a credential related to a device (i.e., a UE identified by subscriber identity) and a service descriptor;

B) determine whether a valid credential exists for the device and the service descriptor; C) send, to the network function, a failure indication in response to determining that the valid credential does not exist for the device and the service descriptor; D) generate a secured packet in response to determining that the valid credential exists for the device and the service descriptor; and E) send, to the network function, the secured packet and credential information including: a subscriber identity corresponding to the device (e.g., SUPI/GPSI), a lifetime for the Secured Packet, a network service identifier (e.g., ENSI/S-NSSAI or DNN/DN-specific ID), a device storage requirement indication (e.g., storage on ME/UICC), or a combination thereof.

In some embodiments, the secured packet contains one or more credentials for slice-specific authentication of the device. In other embodiments, the secured packet contains one or more credentials for secondary authentication of the device. In various embodiments, the service descriptor includes: external network slice information, single network slice selection assistance information, a network access identifier, a data network specific identifier, a data network name, an identity of an AAA server, or a combination thereof.

In some embodiments, the subscriber identity includes a GPSI corresponding to the device. In certain embodiments, the subscriber identity further includes at least one of: an IPV4 address, an IPV6 address, an IMEI, an IPV4v6 address, a MAC address, or a combination thereof. In certain embodiments, the request for the credential is received via a NEF.

In some embodiments, the subscriber identity includes a SUPI corresponding to the device. In certain embodiments, the subscriber identity further includes at least one of: an IPV4 address, an IPV6 address, an IMEI, an IPV4v6 address, a MAC address, or a combination thereof.

In some embodiments, the request for the credential includes a Secured Packet Request. In such embodiments, the Secured Packet Request may be contained within a HTTP POST request. In some embodiments, the failure indication includes a 404 Not Found message or a HTTP POST response message. In some embodiments, to send the secured packet and credential information, the processor is configured to cause the apparatus to send a 200 OK message.

In some embodiments, the requested credential includes a credential for NSSAA, where, to receive the request for the credential for NSSAA, the processor is configured to cause the apparatus to receive, from the network function, a HTTP POST Request including a network slice identifier (e.g., ENSI or S-NSSAI). In such embodiments, the credential information may include the network slice identifier (e.g., ENSI or S-NSSAI).

In some embodiments, the requested credential includes a credential for Secondary Authentication, where, to receive the request for the credential for Secondary Authentication, the processor is configured to cause the apparatus to receive, from the network function, a HTTP POST Request including: a DN-specific ID, a DNN, or a combination thereof. In such embodiments, the credential information may include the DN-specific ID and/or DNN.

In some embodiments, to send the secured packet and the credential information, the processor is configured to cause the apparatus to send a success indication indicating availability of a secured packet. In certain embodiments, the secured packet may include at least one credential for the subscriber identity and the service descriptor.

Disclosed herein is a second method for provisioning a Secured Packet, according to embodiments of the disclosure. The second method may be performed by an application function, such as the AF 146, the SP-AF 315, and/or the network apparatus 800, as described above. The second method includes receiving, from a network function (e.g., NEF or consumer NF), a request for a credential related to a device (i.e., a UE identified by subscriber identity) and a service descriptor. The second method includes determining whether a valid credential exists for the device and the service descriptor and sending, to the network function, a failure indication in response to determining that the valid credential does not exist for the device and the service descriptor. The second method includes generating a secured packet in response to determining that the valid credential exists for the device and the service descriptor and sending, to the network function, the secured packet and credential information including: a subscriber identity corresponding to the device (e.g., SUPI/GPSI), a lifetime for the secured packet, a network service identifier (e.g., ENSI/S-NSSAI or DNN/DN-specific ID), a device storage requirement indication (e.g., storage on ME/UICC), or a combination thereof.

In some embodiments, the secured packet contains one or more credentials for slice-specific authentication of the device. In other embodiments, the secured packet contains one or more credentials for secondary authentication of the device. In various embodiments, the service descriptor includes: external network slice information, single network slice selection assistance information, a network access identifier, a data network specific identifier, a data network name, an identity of an AAA server, or a combination thereof.

In some embodiments, the subscriber identity includes a GPSI corresponding to the device. In certain embodiments, the subscriber identity further includes at least one of: an IPv4 address, an IPV6 address, an IMEI, an IPV4v6 address, a MAC address, or a combination thereof. In certain embodiments, the request for the credential is received via a NEF.

In some embodiments, the subscriber identity includes a SUPI corresponding to the device. In certain embodiments, the subscriber identity further includes at least one of: an IPV4 address, an IPV6 address, an IMEI, an IPV4v6 address, a MAC address, or a combination thereof.

In some embodiments, the request for the credential includes a Secured Packet Request. In such embodiments, the Secured Packet Request may be contained within a HTTP POST request. In some embodiments, the failure indication includes a 404 Not Found message or a HTTP POST response message. In some embodiments, sending the secured packet and credential information includes sending a 200 OK message.

In some embodiments, the requested credential includes a credential for NSSAA, where receiving the request for the credential for NSSAA includes receiving, from the network function, a HTTP POST Request including a network slice identifier (e.g., ENSI or S-NSSAI). In such embodiments, the credential information may include the network slice identifier (e.g., ENSI or S-NSSAI).

In some embodiments, the requested credential includes a credential for Secondary Authentication, where receiving the request for the credential for Secondary Authentication includes receiving, from the network function, a HTTP POST Request including: a DN-specific ID, a DNN, or a combination thereof. In such embodiments, the credential information may include the DN-specific ID and/or DNN.

In some embodiments, sending the secured packet and the credential information includes sending a success indication indicating availability of a secured packet. In certain embodiments, the secured packet may include at least one credential for the subscriber identity and the service descriptor.

Disclosed herein is a third apparatus for provisioning a Secured Packet, according to embodiments of the disclosure. The third apparatus may be implemented by a network device, such as the NEF 145, the NEF 310, and/or the network apparatus 800, as described above. The third apparatus includes a processor coupled to a transceiver configured to communicate with a consumer NF and a SP-AF, where the processor is configured to cause the apparatus to: A) receive, from a network function (e.g., a consumer NF), a first request message for a credential related to a device (i.e., a UE identified by subscriber identity) and a service descriptor, where the first request message includes a destination address; B) send, to a SP-AF using the destination address, a second request message for the credential related to the device and the service descriptor; C) receive, from the SP-AF, a first response message including a secured packet (e.g., containing a credential related to the device and the service descriptor) and credential information, the credential information including: a subscriber identity corresponding to the device (e.g., SUPIGPSI), a lifetime for the Secured Packet, a network service identifier (e.g., ENSI/S-NSSAI or DNN/DN-specific ID), a device storage requirement indication (e.g., storage on ME/UICC), or a combination thereof; and D) send, to the network function, a second response message including the secured packet and the credential information.

In some embodiments, the secured packet contains one or more credentials for slice-specific authentication of the device. In other embodiments, the secured packet contains one or more credentials for secondary authentication of the device. In some embodiments, the first response message and the second response message each include a success indication indicating availability of a secured packet, where the secured packet includes at least one credential for the subscriber identity and the service descriptor.

In some embodiments, the first request message and the second response message each include a SUPI corresponding to the device. In such embodiments, the processor is further configured to cause the apparatus to translate the SUPI to a GPSI corresponding to the device, where the second request message and first response message each include the GPSI.

In certain embodiments, the first request message and second response message each contain a subscriber identity included of the SUPI and at least one of: an IPV4 address, an IPv6 address, an IMEI, an IPV4v6 address, a MAC address, or a combination thereof. In certain embodiments, the second request message and first response message each contain a subscriber identity included of the GPSI and at least one of: an IPV4 address, an IPV6 address, an IMEI, an IPv4v6 address, a MAC address, or a combination thereof.

In various embodiments, the first request message invokes a Nnef service operation, the second request message includes a HTTP POST request message. In some embodiments, the first response message includes a 200 OK message, and the second response message includes a success indication. In other embodiments, the first response message includes a 404 Not Found message or a HTTP POST response message, and the second response message includes a failure indication.

In some embodiments, the credential related to the device and the service descriptor includes a credential for NSSAA, where the first and second request messages each include a network slice identifier (e.g., ENSI or S-NSSAI). In such embodiments, the credential information may include the network slice identifier (e.g., ENSI or S-NSSAI).

In some embodiments, the credential related to the device and the service descriptor includes a credential for Secondary Authentication, where the first and second request messages include: a DN-specific ID, a DNN, or a combination thereof. In such embodiments, the credential information may include the DN-specific ID and/or DNN.

In some embodiments, the first and second request messages each include a Secured Packet Request. In some embodiments, the first request message includes: an identifier of the SP-AF, network address information of the SP-AF, or a combination thereof. In various embodiments, the service descriptor includes: external network slice information, single network slice selection assistance information, a network access identifier, a data network specific identifier, a data network name, an identity of an AAA server, or a combination thereof.

Disclosed herein is a third method for provisioning a Secured Packet, according to embodiments of the disclosure. The third method may be performed by a network device, such as the NEF 145, the NEF 310, and/or the network apparatus 800, as described above. The third method includes receiving, from a network function (e.g., a consumer NF), a first request message for a credential related to a device (i.e., a UE identified by subscriber identity) and a service descriptor, where the first request message includes a destination address. The third method includes sending, to a SP-AF using the destination address, a second request message for the credential related to the device and the service descriptor.

The third method includes receiving, from the SP-AF, a first response message including a secured packet (e.g., containing a credential related to the device and the service descriptor) and credential information, the credential information including: a subscriber identity corresponding to the device (e.g., SUPI/GPSI), a lifetime for the Secured Packet, a network service identifier (e.g., ENSI/S-NSSAI or DNN/DN-specific ID), a device storage requirement indication (e.g., storage on ME/UICC), or a combination thereof. The third method includes sending, to the network function, a second response message including the secured packet and the credential information.

In some embodiments, the secured packet contains one or more credentials for slice-specific authentication of the device. In other embodiments, the secured packet contains one or more credentials for secondary authentication of the device. In some embodiments, the first response message and the second response message each include a success indication indicating availability of a secured packet, where the secured packet includes at least one credential for the subscriber identity and the service descriptor.

In some embodiments, the first request message and the second response message each include a SUPI corresponding to the device. In such embodiments, the third method further including translating the SUPI to a GPSI corresponding to the device, where the second request message and first response message each include the GPSI.

In certain embodiments, the first request message and second response message each contain a subscriber identity included of the SUPI and at least one of: an IPV4 address, an IPv6 address, an IMEI, an IPV4v6 address, a MAC address, or a combination thereof. In certain embodiments, the second request message and first response message each contain a subscriber identity included of the GPSI and at least one of: an IPV4 address, an IPV6 address, an IMEI, an IPv4v6 address, a MAC address, or a combination thereof.

In various embodiments, the first request message invokes a Nnef service operation, the second request message includes a HTTP POST request message. In some embodiments, the first response message includes a 200 OK message, and the second response message includes a success indication. In other embodiments, the first response message includes a 404 Not Found message or a HTTP POST response message, and the second response message includes a failure indication.

In various embodiments, the service descriptor includes: external network slice information, single network slice selection assistance information, a network access identifier, a data network specific identifier, a data network name, an identity of an AAA server, or a combination thereof.

In some embodiments, the credential related to the device and the service descriptor includes a credential for NSSAA, where the first and second request messages each include a network slice identifier (e.g., ENSI or S-NSSAI). In such embodiments, the credential information may include the network slice identifier (e.g., ENSI or S-NSSAI).

In some embodiments, the credential related to the device and the service descriptor includes a credential for Secondary Authentication, where the first and second request messages include: a DN-specific ID, a DNN, or a combination thereof. In such embodiments, the credential information may include the DN-specific ID and/or DNN.

In some embodiments, the first and second request messages each include a Secured Packet Request. In some embodiments, the first request message includes: an identifier of the SP-AF, network address information of the SP-AF, or a combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising:
a transceiver; and
a processor coupled to the transceiver, the processor configured to cause the apparatus to:
send, to a Secured Packet Application Function (“SP-AF”), a request for a credential related to a device and a service descriptor;
receive, from the SP-AF, a secured packet and credential information comprising:
a subscriber identity corresponding to the device,
a lifetime for the Secured Packet,
a network service identifier,
a device storage requirement indication,
or a combination thereof;
store the secured packet and the credential information, the secured packet comprising a valid credential; and
provision the secured packet to the device via an update procedure.

2. The apparatus of claim 1, wherein, to send the request for the credential, the processor is configured to cause the apparatus to invoke a Secured Packet Request, wherein the processor is further configured to cause the apparatus to determine to invoke the Secured Packet Request based on:
a local policy,
a lifetime of a credential,
a non-availability of a credential,
or a combination thereof.

3. The apparatus of claim 1, wherein the requested credential comprises a credential for Network Slice Authentication and Authorization (“NSAA”), and wherein, to send the request for the credential for NSAA, the processor is configured to cause the apparatus to send, to the SP-AF, a HyperText Transport Protocol (“HTTP”) POST Request comprising a network slice identifier.

4. The apparatus of claim 1, wherein the requested credential comprises a credential for Secondary Authentication, and wherein, to send the request for the credential for Secondary Authentication, the processor is configured to cause the apparatus to send, to the SP-AF, a HyperText Transport Protocol (“HTTP”) POST Request comprising: a data network specific identifier, a data network name, or a combination thereof.

5. The apparatus of claim 1, wherein, to send the request for the credential, the processor is configured to cause the apparatus to send the request via a network exposure function (“NEF”), wherein the subscriber identity comprises a Generic Public Subscription Identifier corresponding to the device.

6. The apparatus of claim 5, wherein, to send the request for the credential, the processor is configured to cause the apparatus to invoke a Nnef service operation, wherein the request for the credential comprises:
an identifier of the SP-AF,
network address information of the SP-AF,
or a combination thereof.

7. The apparatus of claim 1, wherein the subscriber identity comprises a Subscription Permanent Identifier corresponding to the device.

8. An apparatus comprising:
a transceiver; and
a processor coupled to the transceiver, the processor configured to cause the apparatus to:
receiving, from a network function, a request for a credential related to a device and a service descriptor;
determining whether a valid credential exists for the device and the service descriptor;
sending, to the network function, a failure indication in response to determining that the valid credential does not exist for the device and the service descriptor;
generating a secured packet in response to determining that the valid credential exists for the device and the service descriptor, the secured packet comprising the valid credential; and
sending, to the network function, the secured packet and credential information comprising:
a subscriber identity corresponding to the device,
a lifetime for the Secured Packet,
a network service identifier,
a device storage requirement indication,
or a combination thereof.

9. The apparatus of claim 8, wherein the service descriptor comprises:
external network slice information,
single network slice selection assistance information,
a network access identifier,
a data network specific identifier,
a data network name,
an identity of an authentication, authorization, and accounting (“AAA”) server,
or a combination thereof.

10. The apparatus of claim 8, wherein the subscriber identity corresponding to the device comprises at least a Generic Public Subscription Identifier and one of:
an IPv4 address,
an IPV6 address,
an International Mobile Equipment Identity (“IMEI”),
an IPv4v6 address,
or a Medium Access Control (“MAC”) address.

11. The apparatus of claim 8, wherein the subscriber identity corresponding to the device comprises at least a Subscription Permanent Identifier and one of:
an IPv4 address,
an IPV6 address,
an International Mobile Equipment Identity (“IMEI”),
an IPv4v6 address,
or a Medium Access Control (“MAC”) address.

12. The apparatus of claim 8, wherein the request for the credential for NSAA comprises a HyperText Transport Protocol (“HTTP”) POST request message, wherein the failure indication comprises a 404 Not Found message or a HTTP POST response message, and wherein, to send the secured packet and the credential information, the processor is configured to cause the apparatus to send a 200 OK message.

13. An apparatus comprising:
a transceiver; and
a processor coupled to the transceiver, the processor configured to cause the apparatus to:
receive, from a network function, a first request message for a credential related to a device and a service descriptor, the first request message comprising a destination address;
send, to a Secured Packet Application Function (“SP-AF”) using the destination address, a second request message for the credential related to the device and the service descriptor;
receive, from the SP-AF, a first response message comprising a secured packet and credential information comprising:
a subscriber identity corresponding to the device,
a lifetime for the Secured Packet,
a network service identifier,
a device storage requirement indication,
or a combination thereof; and
send, to the network function, a second response message comprising the secured packet and the credential information.

14. The apparatus of claim 13, wherein the first response message and the second response message each comprise a success indication indicating availability of a secured packet, and wherein the secured packet comprises at least one credential for the subscriber identity and the service descriptor.

15. The apparatus of claim 13, wherein the first request message and the second response message each comprise a subscription permanent identifier (“SUPI”) corresponding to the device, wherein the processor is further configured to cause the apparatus to translate the SUPI to a generic public subscription identifier (“GPSI”) corresponding to the device, and wherein the second request message and first response message each comprise the GPSI.
